(19) United States
(12) Patent Application Publication
(10) Pub. No.: US 2014/0134625 A1
(43) Pub. Date: May 15, 2014

(54) METHODS AND SYSTEMS FOR PREDICTIVE MODELING OF HIV-1 REPLICATION CAPACITY

(71) Applicant: Laboratory Corporation of America Holdings, Burlington, NC (US)

(72) Inventors: Mojgan Haddad, Orinda, CA (US); Sebastian Bonhoeffer, Zurich (CH); Trevor Hinkley, London (GB)

(73) Assignee: Laboratory Corporation of America Holdings, Burlington, NC (US)

(21) Appl. No.: 13/978,978

(22) PCT Filed: Jan. 12, 2012
(86) PCT No.: PCT/US12/21080

§ 371 Date: Jan. 28, 2014

Related U.S. Application Data
(60) Provisional application No. 61/432,271, filed on Jan. 13, 2011.

(51) Int. Cl. G06F 19/22

(52) U.S. Cl. CPC G06F 19/22
USPC 435/6.12; 702/20

(57) ABSTRACT

Methods, systems, and computer readable media perform predictive modeling of gene activity. The methods may comprise obtaining the amino acid and/or nucleic acid sequence of a portion of the at least one gene from a biological sample obtained from a subject; comparing the amino acid and/or nucleic acid sequence of the portion of the at least one gene to a database of sequences for the portion of the at least one gene and for which the biological activity of the at least one gene has been evaluated; and applying a generalization of ridge regression analysis to estimate the effects of individual mutations in the at least one gene. A model is based on generalization of ridge regression (GRR) analysis to estimate the effects of individual mutations in at least one gene for the subject. At least one gene may comprise the reverse transcriptase and protease genes of an HIV vims.

### CROSS-REFERENCE TO RELATED APPLICATIONS

The present application claims the benefit of priority to U.S. Provisional Patent Application No. 61/432,271, filed Jan. 13, 2011, the entirety of which is incorporated by reference as though fully set forth herein.

### FIELD OF THE INVENTION

The invention provides methods and systems for predictive modeling of gene activity. The invention further provides systems and computer-readable media for performing methods for predictive modeling of gene activity. In some embodiments, the gene activity relates to HIV-1 replication capacity.

### BACKGROUND

Several dozen different drugs have been approved to treat HIV infection. The effectiveness of these drugs may vary from subject to subject, which depends, at least in part, on genetically-controlled resistance to certain treatments. Over 200 mutations associated with resistance have been identified. Thus, it is increasingly difficult to develop a comprehensive understanding of HIV drug resistance. Resistance mutations differ in their potency to resist drug pressure, they vary in their degree of cross-resistance to different drugs or drug classes, and they differ in the fitness costs induced in the absence of treatment. Moreover their effects depend, to varying degrees, on the context of accompanying mutations. The quantitative dissection of the fitness effects of resistance mutations in the presence or absence of drugs and in particular the determination how the effect of mutations depend on the presence or absence of other mutations thus represents a major challenge.

The delineation of epistatic interactions between mutations is not only a matter of the size of the data set. The combinatorial complexity of the genetic context in which various mutations appear explodes to a degree such that the estimation of the fitness effects is not feasible with standard statistical approaches, because the number of parameters to be estimated easily outnumbers the number of data points available even for the largest data sets. Problems in which the combinatorial complexity overwhelms standard methods of parameter inference are a common challenge in systems biology, although various approaches have been developed that allow a reliable parameter estimation under conditions that lead to overfitting with standard statistical approaches.

Therefore, there is a continuing need for methods and systems to analyze genetic information and allow for the identification of a treatment protocol that may provide for less incidence of HIV drug resistance.

### SUMMARY OF THE INVENTION

In at least one aspect, the invention provides a method to predict the activity of at least one gene comprising: (a) obtaining an amino acid and/or nucleic acid sequence of a portion of the at least one gene from a biological sample obtained from a subject, where the portion of the at least one gene comprises a region of the gene that if mutated can affect the activity of the at least one gene; (b) measuring a biological activity that depends on the activity of the at least one gene in the sample; (c) comparing the amino acid and/or nucleic acid sequence of the portion of the at least one gene to sequence data stored in a database, the data comprising a plurality of sequences for the portion of the at least one gene and for which the biological activity of the at least one gene has been evaluated; (d) determining if there is a mutation in the portion of the at least one gene in the biological sample obtained from the subject; and (e) applying a model based on generalization of ridge regression (GRR) analysis to estimate the effects of individual mutations in the at least one gene for the subject.

In another aspect, the invention provides a method to develop a model to predict the activity of at least one gene comprising: (a) obtaining the amino acid and/or nucleic acid sequence of a portion of the at least one gene from a biological sample obtained from a subject, where the portion of the at least one gene comprises a region of the gene that if mutated can affect the activity of the at least one gene; (b) measuring a biological activity that depends on the activity of the at least one gene in the sample; (c) comparing the amino acid and/or nucleic acid sequence of the portion of the at least one gene to sequence data stored in a database, the data comprising a plurality of sequences for the portion of the at least one gene and for which the biological activity of the at least one gene has been evaluated; (d) determining if there is a mutation in the portion of the at least one gene in the biological sample obtained from the subject; and (e) applying a generalized ridge regression (GRR) analysis to develop a model to estimate the effects of individual mutations in the at least one gene for the subject.

In another aspect, the invention provides a system comprising: a computer readable medium; and a processor in communication with the computer readable medium, the processor configured to: receive sequence data, the sequence data representing an amino acid and/or nucleic, acid sequence of a portion of at least one gene from a biological sample obtained from a subject; measure a biological activity that depends on the activity of the at least one gene; access other sequence data and previously evaluated biological activity of the at least one gene; compare the received sequence data to the other sequence data; determine whether there is a mutation in the received sequence data; and in response to a determination that there is the mutation in the received sequence data, estimate the effects of at least one individual mutation by at least applying a model based on a generalization of ridge regression (GRR) analysis.

In another aspect, the invention provides a computer readable medium comprising program code comprising: program code for receiving sequence data, the sequence data representing an amino acid and/or nucleic acid sequence of a portion of at least one gene from a biological sample obtained from a subject; program coded for measuring a biological activity that depends on the activity of the at least one gene; program code for accessing other sequence data and previously evaluated biological activity of the at least one gene; program code for comparing the received sequence data to the other sequence data; program code for determining whether there is a mutation in the received sequence data; and program code for, in response to a determination that there is the mutation in the received sequence data, estimating the effects of at least one individual mutation by at least applying a model based on a generalization of ridge regression (GRR) analysis.

Further aspects of the invention, and further embodiments of each of the above aspects, are described in greater detail below.

### BRIEF DESCRIPTION OF THE DRAWINGS

FIGS. 1-13 are included as part of the description of the invention. These figures are intended to illustrate certain embodiments of the claimed inventions, but are do not themselves limit the scope of the claimed inventions in any way. Thus, the claimed inventions may include embodiments and/or features that are not specifically shown in the following figures.

FIG. 1 shows an analysis of predictive power in accordance with certain embodiments of the present invention. The figure shows the predictive power of the Main Effects (ME) model (left bars in each pair) and Main Effects and EPistatic Interactions (MEEP) model (right bars in each pair) in a drug free and 15 drug containing environments. The predictive power is measured by the percentage deviance explained in a cross-validation data set based on 5,000 independent virus samples. The bars represent the mean, and the whiskers on the top of each bar represent the standard errors of a six-fold cross-validation based on random subdivision of the data into independent training and test sets of size 65,000 and 5,000, respectively. It can be seen that for this data set, the MEEP model outperforms the ME model in all environments.

FIG. 2 shows an analysis of predictive power of different epistatic models for four representative environments in accordance with certain embodiments of the present invention. For each set of bars (i.e., no drug, DLV, ABC and LPC), the left most bar corresponds to the ME model; the next bar corresponds to the ME+intergenic interaction model; the next bar corresponds to the ME+intragenic interaction model; and the last bar corresponds to the MEEP model. The figure shows that most of the predictive power attributable to epistasis is in fact attributable to intra- rather than intergenic epistatic interactions. In the non-nucleoside reverse transcriptase inhibitor (NNRTI) environment adding intergenic epistasis decreases predictive power. This decrease reflects that adding a large number of parameters with little or no explanatory power can reduce the predictive power of generalized kernel ridge regression (GKRR). The bars represent mean and the whiskers the standard errors of a six-fold cross-validation based on random subdivision of the data into independent training and test sets of size 65,000 and 5,000, respectively.

FIG. 3 shows a cumulative strength of the absolute epistatic effects in the HIV-1 protease (PR) as measured in the drug-free environment in accordance with certain embodiments of the present invention. The cumulative effect between two positions is calculated as the sum over the absolute values of all epistatic interactions between the amino acid variants at those positions as estimated by the MEEP model. The protease regions corresponding to the flap elbow, fulcrum and cantilever, colored in red (˜amino acids 37-43), yellow (˜amino acids 8-24), and green (˜amino acids 60-72), respectively, are significantly enriched in epistasis (see FIG. 4). The inset shows the structure of the HIV-1 PR (Protein Data Bank ID 1A30, rendered with PyMOL, http//www.pymol.org). The region enriched in epistatic interaction, corresponding to the flap elbow, is somewhat larger than the literature description of this region (See, for example, Homak et al., Proc. Nat'l Acad. Sci., Vol. 103, pp. 915-920 (2006).)

FIG. 4 shows a statistical test of enrichment of epistasis in fulcrum, cantilever and flap elbow in the HIV-1 protease in accordance with certain embodiments of the present invention. The plots are identical to FIG. 3 except for the coloring. For both plots the method tests whether interactions are enriched in the cyan (lighter shading) compared to the magenta (darker shading) regions. Panel A thus compares the epistatic interactions between fulcrum, cantilever, and flap elbow and the rest of the protein to all other remaining interactions. The mean absolute epistasis in the cyan and magenta regions is 0.1176 and 0.0282, respectively. Bootstrap analysis by random shuffling of the positions in the protease reveals that the mean in the cyan region is significantly higher (p<10⁻⁵ based on 100,000 repeats). In panel B the cyan region corresponds to the interactions within and between the fulcrum, cantilever, and flap elbow and the magenta region corresponds to the interactions between these regions and the rest of the protease. The means of the cyan and magenta regions are 0.277 and 0.0728. Bootstrap analysis also confirms that these means are significantly different (p<10⁻⁵ based on 100,000 repeats).

FIG. 5 shows cumulative absolute epistatic effects versus physical proximity (Å) in the HIV-1 protease in accordance with certain embodiments of the present invention. The strength of the epistatic effect is measured as in FIG. 3. Physical proximity is correlated to the cumulative absolute epistatic effect (p=0.039 based on 100,000 bootstrap repeats).

FIG. 6 shows relative predictive power under varying lambda in accordance with certain embodiments of the present invention. Lambda was varied from its position as calculated with the square root approximation and the corresponding predictive power (relative to the predictive power for the calculated lambda) was measured against the cross validation set under environments NODRUG, 3TC, and ABC. The maximum possible predictive power is indicated by a circle (for optimal lambda choice). Lambda as would be calculated using a full GKRR for each bisection interval is shown by a triangle. NODRUG (the curve with the maximum at about 0.6 lambda) shows the same prediction for lambda, 3TC (the curve with the maximum at about 1.8 lambda) shown a better prediction for lambda and ABC (the curve with a maximum at about 1.5 lambda) shows a worse prediction. It can be seen that in all cases, the prediction (both for the square root approximation and for a GKRR approximation) for the final lambda differs from the optimal lambda, in predictive power, by less than 1%. It can therefore be concluded that the square root approximation for lambda is robust.

FIG. 7 shows a flow chart directed to a method of predicting the activity of at least one gene according to an embodiment.

FIG. 8 shows a flow chart directed to a method of developing a model to predict the activity of at least one gene according to an embodiment.

FIGS. 9A and 9B show system diagrams depicting exemplary computing devices in exemplary computing environments according to various embodiments.

FIGS. 10A and 10B show block diagrams depicting exemplary computing devices according to various embodiments.

FIG. 11 shows the relation between the predicted Replicative Capacity (pRC) and virus load, measured as log₁₀ (copies of RNA/mL) in the RNA-load set. For the data shown, the regression line is: (HIV RNA)=1.068+(0.525)(ERC); the F-test is p<0.001; and the R² is 0.034.

FIG. 12 shows the temporal increase of the predicted Replicative Capacity (pRC) in the Longitudinal Dataset in terms of the relation between time difference between sequence samples and the change in the pRC. For the data shown, the regression line is: (Delta ERC)=−0.009+(0.020)(Years); the F-test is p=0.005; and the R² is 0.094.

FIG. 13 shows the relation between change in predicted Replicative Capacity (pRC) and change in RNA-load in the Longitudinal Dataset. For the data shown, the regression line is: (Delta HIV RNA)=0.226+(0.900)(Delta ERC); the F-test is p=0.040; and the R² is 0.075.

### DETAILED DESCRIPTION

The following paragraphs provide a description of various embodiments of the invention. Such embodiments are intended to describe methods and systems that are included within the scope of the invention, but are not intended to serve as a limit to the scope of the claimed subject matter. The claims shall determine the scope of the invention.

### DEFINITION AND ABBREVIATIONS

The following definitions and abbreviations are provided for convenience. The application may use various terms and phrases, including technical terms and phrases, that are not expressly defined herein. When a term or phrase is not expressly defined, the term or phrase shall have the meaning that such term of phrase would have to the person of ordinary skill in the art in the field(s) to which the invention is directed.

Unless noted otherwise, the standard one-letter and three-letter abbreviations for amino acids are used. When polypeptide sequences are presented as a series of one-letter and/or three-letter abbreviations, the sequences are presented in the N→C direction, in accordance with common practice. Also, where specified, individual amino acids in a sequence are represented herein as AN, wherein A is the standard one letter symbol for the amino acid in the sequence, and N is the position in the sequence. Mutations are represented herein as A₁NA₂, wherein A₁ is the standard one letter symbol for the amino acid in the reference protein sequence, A₂ is the standard one letter symbol for the amino acid in the mutated protein sequence, and N is the position in the amino acid sequence. For example, a G25M mutation represents a change from glycine to methionine at amino acid position 25. Mutations may also be represented herein as NA₂, wherein N is the position in the amino acid sequence and A₂ is the standard one letter symbol for the amino acid in the mutated protein sequence (e.g., 25M, for a change from the wild-type amino acid to methionine at amino acid position 25). Additionally, mutations may also be represented herein as A₁N, wherein A₁ is the standard one letter symbol for the amino acid in the reference protein sequence and N is the position in the amino acid sequence (e.g., G25 represents a change from glycine to any amino acid at amino acid position 25). This notation is typically used when the amino acid in the mutated protein sequence is either not known or, if the amino acid in the mutated protein sequence could be any amino acid, except that found in the reference protein sequence. The amino acid positions are numbered based on the full-length sequence of the protein from which the region encompassing the mutation is derived. Representations of nucleotides and point mutations in DNA sequences are analogous.

The abbreviations used throughout the specification to refer to nucleic acids comprising specific nucleobase sequences are the conventional one-letter abbreviations. Thus, when included in a nucleic acid, the naturally occurring encoding nucleobases are abbreviated as follows: adenine (A), guanine (G), cytosine (C), thymine (T) and uracil (U). Unless specified otherwise, single-stranded nucleic acid sequences that are represented as a series of one-letter abbreviations, and the top strand of double-stranded sequences, are presented in the 5′→3′ direction.

Unless otherwise specified, “primary mutation” refers to a mutation that affects the enzyme active site (e.g., at those amino acid positions that are involved in the enzyme-substrate complex) or that reproducibly appears in an early round of replication when a virus is subject to the selective pressure of an antiviral agent, or, that has a large effect on phenotypic susceptibility to an antiviral agent. A “secondary mutation” refers to a mutation that is not a primary mutation and that contributes to reduced susceptibility or compensates for gross defects imposed by a primary mutation.

A “phenotypic assay” is a test that measures the sensitivity of a virus (such as HIV) to a specific anti-viral agent. A “genotypic assay” is a test that determines a genetic sequence of an organism, a part of an organism, a gene or a part of a gene. Such assays are frequently performed in HIV to establish whether certain mutations are associated with drug resistance are present.

As used herein, “genotypic data” are data about the genotype of, for example, a virus. Examples of genotypic data include, but are not limited to, the nucleotide or amino acid sequence of a virus, a part of a virus, a viral gene, a part of a viral gene, or the identity of one or more nucleotides or amino acid residues in a viral nucleic acid or protein.

“Susceptibility” refers to a virus' response to a particular drug. A virus that has decreased or reduced susceptibility to a drug has an increased resistance or decreased sensitivity to the drug. A virus that has increased or enhanced or greater susceptibility to a drug has an increased sensitivity or decreased resistance to the drug.

Generally, phenotypic susceptibility of a virus to a given drug is a continuum. Nonetheless, it may be practically useful to define a threshold or thresholds to simplify interpretation of a particular fold-change result. For drugs where sufficient clinical outcome data have been gathered, it is possible to define a clinical cutoff value, as below. The term “clinical cutoff value” refers to a specific point at which resistance begins and sensitivity ends. It is defined by the drug susceptibility level at which a subject's probability of treatment failure with a particular drug significantly increases. The cutoff value is different for different anti-viral agents, as determined in clinical studies. Clinical cutoff values are determined in clinical trials by evaluating resistance and outcomes data. Drug susceptibility (phenotypic) is measured at treatment initiation. Treatment response, such as change in viral load, is monitored at predetermined time points through the course of the treatment. The drug susceptibility is correlated with treatment response and the clinical cutoff value is determined by resistance levels associated with treatment failure (statistical analysis of overall trial results).

The term “ICₙ” refers to inhibitory concentration. It is the concentration of drug in the subject's blood or in vitro needed to suppress the reproduction of a disease-causing microorganism (such as HIV) by n %. Thus, “IC₅₀” refers to the concentration of an antiviral agent at which virus replication is inhibited by 50% of the level observed in the absence of the drug. The term “Subject IC₅₀” refers to the drug concentration required to inhibit replication of the virus from a subject by 50% and “reference IC₅₀” refers to the drug concentration required to inhibit replication of a reference or wild-type virus by 50%. Similarly, “IC₉₀” refers to the concentration of an anti-viral agent at which 90% of virus replication is inhibited.

A “fold change” is a numeric comparison of the drug susceptibility of a subject virus and a drug-sensitive reference virus. For example, the ratio of the Subject IC₅₀ to the drug-sensitive reference IC50, i.e., Subject IC₅₀/Reference IC₅₀ is a Fold Change (“FC”). A fold change of 1.0 indicates that the subject virus exhibits the same degree of drug susceptibility as the drug-sensitive reference virus. A fold change less than 1 indicates the subject virus is more sensitive than the drug-sensitive reference virus. A fold change greater than 1 indicates the subject virus is less susceptible than the drug-sensitive reference virus. A fold change equal to or greater than the clinical cutoff value means the subject virus has a lower probability of response to that drug. A fold change less than the clinical cutoff value means the subject virus is sensitive to that drug.

A virus may have an “increased likelihood of having reduced susceptibility” to an anti-viral treatment if the virus has a property, for example, a mutation, that is correlated with a reduced susceptibility to the anti-viral treatment. A property of a virus is correlated with a reduced susceptibility if a population of viruses having the property is, on average, less susceptible to the anti-viral treatment than an otherwise similar population of viruses lacking the property. Thus, the correlation between the presence of the property and reduced susceptibility need not be absolute, nor is there a requirement that the property is necessary (e.g., that the property plays a causal role in reducing susceptibility) or sufficient (e.g., that the presence of the property alone is sufficient) for conferring reduced susceptibility.

The term “% sequence homology” is used interchangeably herein with the terms “% homology,” “% sequence identity” and “% identity” and refers to the level of amino acid sequence identity between two or more peptide sequences, when aligned using a sequence alignment program. For example, as used herein, 80% homology means the same thing as 80% sequence identity determined by a defined algorithm, and accordingly a homologue of a given sequence has greater than 80% sequence identity over a length of the given sequence. In some embodiments of the invention, levels of sequence identity include, but are not limited to, 60% or more, 70% or more, 80% or more, 85% or more, 90% or more, 95% or more, or 98% or more sequence identity to a given sequence.

Various computer programs may be used to determine identity between two sequences. Such computer programs include, but are not limited to, the suite of BLAST programs, e.g., BLASTN, BLASTX, and TBLASTX, BLASTP and TBLASTN, publicly available on the Internet at http://www.ncbi.nlm.nih.gov/BLAST/. See also Altschul et al., J. Mol. Biol. Vol. 215, pp. 403-10 (1990) (with special reference to the published default setting, i.e., parameters w=4, t=17) and Altschul et al., Nucleic Acids Res. Vol. 25, pp. 3389-3402 (1997). Sequence searches are typically carried out using the BLASTP program when evaluating a given amino acid sequence relative to amino acid sequences in the GenBank Protein Sequences and other public databases. The BLASTX program is suitable for searching nucleic acid sequences that have been translated in all reading frames against amino acid sequences in the GenBank Protein Sequences and other public databases. Both BLASTP and BLASTX are run using default parameters of an open gap penalty of 11.0, and an extended gap penalty of 1.0, and utilize the BLOSUM-62 matrix. See Altschul, et al. (1997).

A preferred alignment of selected sequences in order to determine “% identity” between two or more sequences, is performed using for example, the CLUSTAL-W program in MacVector version 6.5, operated with default parameters, including an open gap penalty of 10.0, an extended gap penalty of 0.1, and a BLOSUM 30 similarity matrix.

The term “polar amino acid” refers to a hydrophilic amino acid having a side chain that is uncharged at physiological pH, but which has at least one bond in which the pair of electrons shared in common by two atoms is held more closely by one of the atoms. Genetically encoded polar amino acids include Asn (N), Gln (Q) Ser (S), and Thr (T).

The term “nonpolar amino acid” refers to a hydrophobic amino acid having a side chain that is uncharged at physiological pH and which has bonds in which the pair of electrons shared in common by two atoms is generally held nearly equally by each of the two atoms (e.g., the side chain is not polar). Genetically encoded nonpolar amino acids include Ala (A), Gly (G), Ile (I), Leu (L), Met (M,) and Val (V).

The term “hydrophilic amino acid” refers to an amino acid exhibiting a hydrophobicity of less than zero according to the normalized consensus hydrophobicity scale of Eisenberg et al., J. Mol. Biol. Vol. 179, pp. 125-142 (1984). Genetically encoded hydrophilic amino acids include Arg (R), Asn (N), Asp (D), Glu (E), Gin (Q), His (H), Lys (K), Ser (S), and Thr (T).

The term “hydrophobic amino acid” refers to an amino acid exhibiting a hydrophobicity of greater than zero according to the normalized consensus hydrophobicity scale of Eisenberg et al., (1984). Genetically encoded hydrophobic amino acids include Ala (A), Gly (G), Ile (I), Leu (L), Met (M), Phe (F), Pro (P), Trp (W), Tyr (Y), and Val (V).

The term “acidic amino acid” refers to a hydrophilic amino acid having a side chain pK value of less than 7. Acidic amino acids typically have negatively charged side chains at physiological pH due to loss of a hydrogen ion. Genetically encoded acidic amino acids include Asp (D) and Glu (E).

The term “basic amino acid” refers to a hydrophilic amino acid having a side chain pK value of greater than 7. Basic amino acids typically have positively charged side chains at physiological pH due to association with hydronium ion. Genetically encoded basic amino acids include Arg (R), His (H), and Lys (K).

A “mutation” is a change in an amino acid sequence or in a corresponding nucleic acid sequence relative to a reference nucleic acid or polypeptide. For embodiments of the invention comprising HIV protease or reverse transcriptase, the reference nucleic acid encoding protease or reverse transcriptase is the protease or reverse transcriptase coding sequence, respectively, present in NL4-3 HIV (GenBank Accession No. AF324493). Likewise, the reference protease or reverse transcriptase polypeptide is that encoded by the NL4-3 HIV sequence. Although the amino acid sequence of a peptide can be determined directly by, for example, Edman degradation or mass spectroscopy, more typically, the amino sequence of a peptide is inferred from the nucleotide sequence of a nucleic acid that encodes the peptide. Any method for determining the sequence of a nucleic acid known in the art can be used, for example, Maxam-Gilbert sequencing (Maxam et al., Methods in Enzymology Vol. 65, p. 499 (1980)), dideoxy sequencing (Sanger et al., Proc. Natl. Acad. Sci. Vol. 74, p. 5463 (1977)) or hybridization-based approaches (see e.g., Sambrook et al., MOLECULAR CLONING: A LABORATORY MANUAL, COLD SPRING HARBOR LABORATORY (3.sup.rd ed., 2001); and Ausubel et al., CURRENT PROTOCOLS IN MOLECULAR BIOLOGY, GREENE PUBLISHING ASSOCIATES AND WILEY INTERSCIENCE (1989)).

A “resistance-associated mutation” (“RAM”) in a virus is a mutation correlated with reduced susceptibility of the virus to anti-viral agents. A RAM can be found in several viruses, including, but not limited to a human immunodeficiency virus (“HIV”). Such mutations can be found in one or more of the viral proteins, for example, in the protease, integrase, envelope or reverse transcriptase of HIV. A RAM is defined relative to a reference strain. For embodiments of the invention comprising HIV protease, the reference protease is the protease encoded by NL4-3 HIV (GenBank Accession No. AF324493).

A “mutant” is a virus, gene or protein having a sequence that has one or more changes relative to a reference virus, gene or protein.

The terms “peptide,” “polypeptide” and “protein” are used interchangeably throughout.

The terms “reference” and “wild-type” are used interchangeably throughout.

The terms “polynucleotide,” “oligonucleotide” and “nucleic acid” are used interchangeably throughout.

### Methods and Systems to Analyze Gene Activity

The methods and systems described herein may be applied to the analysis of gene activity from any source (e.g., biological samples obtained from humans and the like, cell culture samples, samples obtained from plants or insects).

In some embodiments of the invention, the sample comprises a virus. In some such embodiments, the virus is an HIV-1. Also, as noted herein, the method may be applied to either nucleic acid or amino acid sequence data. For example, in some embodiments, the method is used to analyze amino acid sequences in a protein. However, the method may also be used to analyzed changes in gene activity that can occur as a result of mutations in non-coding (e.g., promoters, enhancers) regions.

In some embodiments, where the sequence data is a mutation, the sequence is compared to a reference. For example, in some such embodiments, the reference HIV is NL4-3.

Methods of analyzing and characterizing genes from various samples are known in the art. See, for example, U.S. Pat. No. 7,384,734 and U.S. Patent Publication No. 2004/0248084, which are incorporated by reference in their entireties, and specifically those portions of their specifications that refer to abbreviations, definitions, the virus, and viral samples that may be used, methods to detect the presence or absence of mutations in a virus, and methods for measuring the phenotypic susceptibility of a mutant virus.

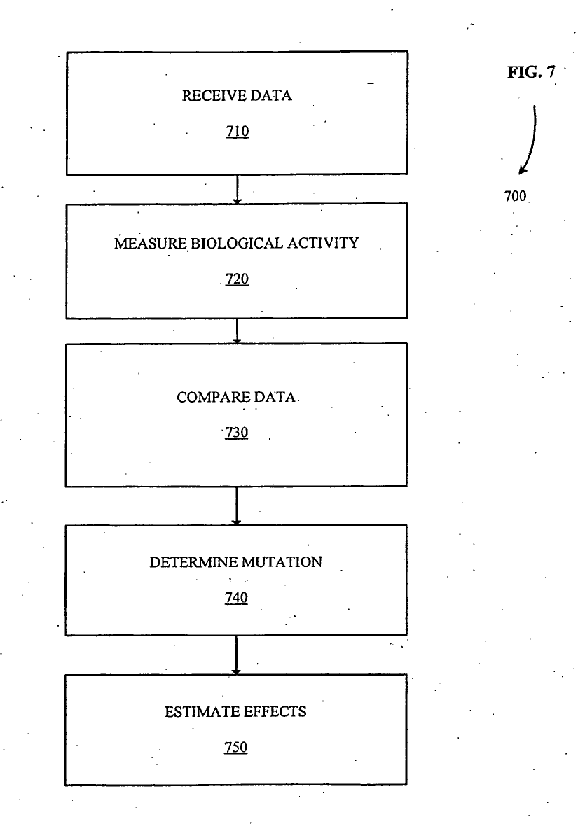

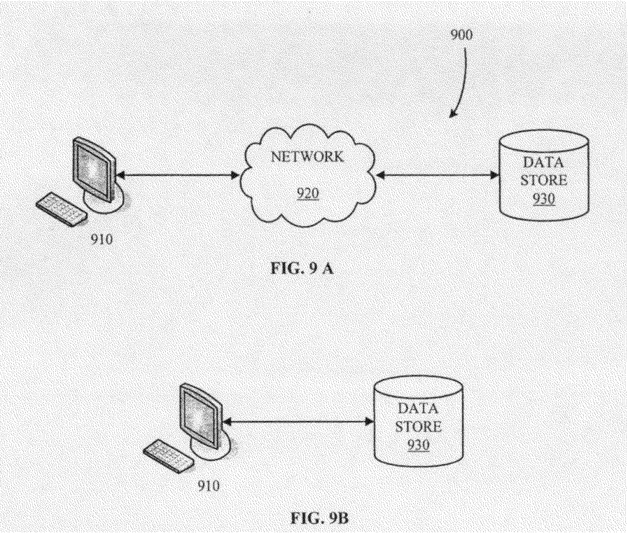

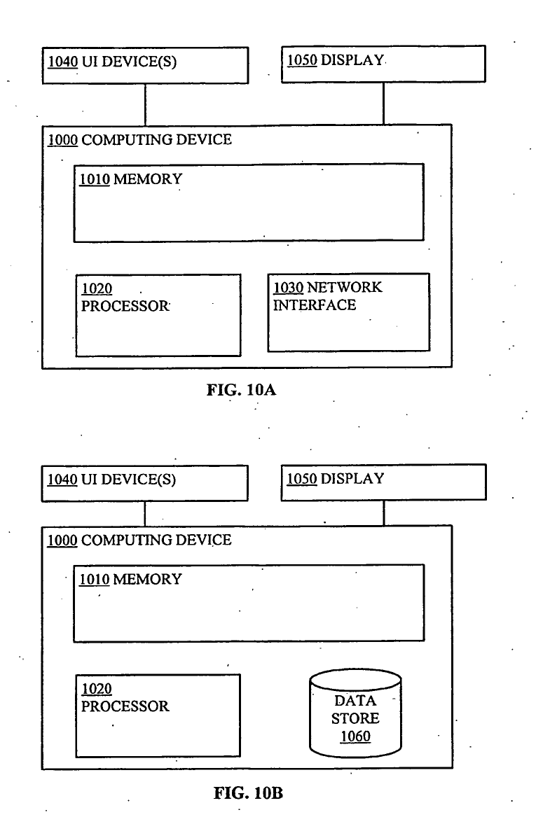

Referring now to FIG. 7, FIG. 7 illustrates a flow chart directed to a method 700 of predicting the activity of at least one gene according to an embodiment. The method shown in FIG. 7 will be described with respect to the system shown in FIGS. 9A and 9B and the electronic device shown in FIGS. 10A and 10B.

In the embodiment shown in FIG. 7, the invention provides methods for developing a model to predict the activity of at least one gene, the method comprising: (a) obtaining the nucleic acid and/or amino acid sequence of a portion of the at least one gene from a biological sample obtained from a subject, where the portion of the at least one gene comprises a region of the gene that if mutated can affect the activity of the at least one gene 710; (b) measuring a biological activity that depends on the activity of the at least one gene in the subject's sample 720; (c) comparing the nucleic acid and/or amino acid sequence of the portion of the at least one gene to sequence data stored in a database, the data comprising a plurality of sequences for the portion of the at least one gene and for which the biological activity of the at least one gene has been evaluated 730; (d) determining if there is a mutation in the portion of the at least one gene in the biological sample obtained from the subject 740; and (e) applying a generalized ridge regression (GRR) analysis to develop a model to estimate the effects of individual mutations in the at least one gene for the subject 750.

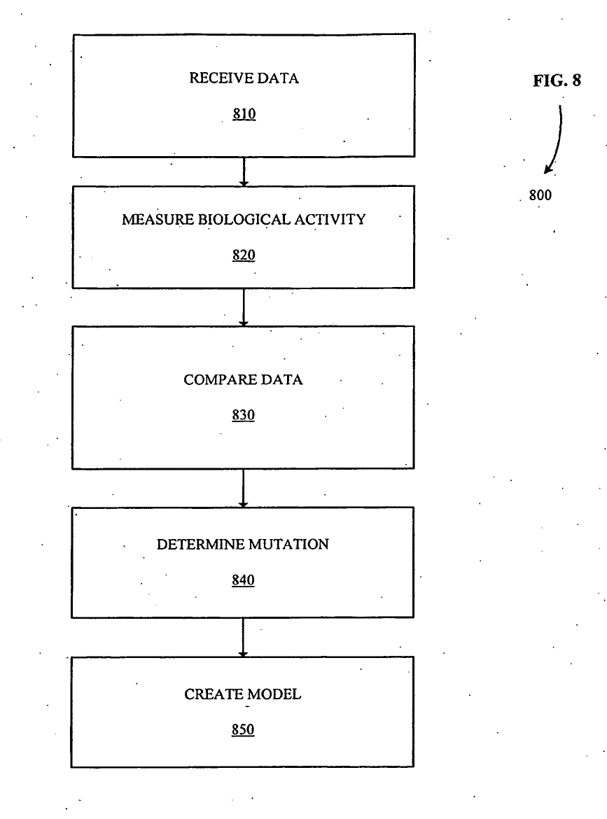

Referring now to FIG. 8, FIG. 8 illustrates a flow chart directed to a method 800 of developing a model to predict the activity of at least one gene according to an embodiment. The method shown in FIG. 8 will be described with respect to the system shown in FIGS. 9A and 9B and the electronic device shown in FIGS. 10A and 10B:

In the embodiment shown in FIG. 8, the invention provides methods for predicting the activity of a gene. For example, in some embodiments, the invention provides a method to predict the activity of at least one gene, the method comprising: (a) obtaining the nucleic acid and/or amino acid sequence of a portion of the at least one gene from a biological sample obtained from a subject, where the portion of the at least one gene comprises a region of the gene that if mutated can affect the activity of the at least one gene 810; (b) measuring a biological activity that depends on the activity of the at least one gene in the subject's sample 820; (c) comparing the nucleic acid and/or amino acid sequence of the portion of the at least one gene to sequence data stored in a database, the data comprising a plurality of sequences for the portion of the at least one gene and for which the biological activity of the at least one gene has been evaluated 830; (d) determining if there is a mutation in the portion of the at least one gene in the biological sample obtained from the subject 840; and (e) applying a model based on generalization of ridge regression (GRR) analysis to estimate the effects of individual mutations in the at least one gene for the subject 850.

In some embodiments, the GRR model is as follows:

$$log ( {W}_{i} ) = I + {\sum }_{j = 1}^{{N}_{M}} {M}_{{ij}^{\hat{}} ij} + {\sum }_{k = 1}^{{N}_{E}} {E}_{ik} {χ}_{k}$$

wherein Wᵢ is the biological activity for sequence I, I is the intercept, which represents the biological activity for a non-mutated reference sequence, γⱼ represents the main effect of the j^{th} variant and Mᵢⱼ is a variable that describes the presence of that variant in sequence i.

The methods of the invention may be applied to various genes. In certain embodiments, the at least one gene comprises the reverse transcriptase (RT) and protease (PR) genes of an HIV virus. For example, in at least some embodiments, the biological activity Wᵢ is replicative capacity for a virus.

The method may be used to determine if certain drugs cause mutations that can affect the biological activity of the at least one gene. For example, in certain embodiments, the subject has been exposed to a drug or other compound (e.g., an antibody) that can affect the biological activity of the at least one gene.

The gene sequences and biological measurements of gene activity as assessed from a particular subject may be compared to a database of biological measurements of gene activity and/or nucleic acid sequence data and/or amino acid sequence data. In certain embodiments, the database includes nucleic acid and/or amino acid sequences and corresponding biological activity measurements for the at least one gene from subjects who have been exposed to a drug that can affect the biological activity of the at least one gene.

Mutations in a gene may be assessed individually or epistatic interactions may be considered. Thus in certain embodiments, the GRR analysis estimates the fitness effects of individual mutations in isolation (main effects) and/or the fitness effects resulting from pairwise epistasis between these mutations (interactions). For example, the analysis may estimate the effect of mutations in isolation as main effects (ME) either alone or in combination with other mutations as epistasis effects (MEEP) so as to provide a prediction of the biological activity of the at least one gene.

A variety of statistical techniques may be employed to develop the model. In certain embodiments, the GRR analysis comprises a weighted ridge regression. Such weighted regression techniques are described in detail herein. For example, in certain embodiments, the GRR analysis comprises a weighted kernel ridge regression as described in more detail herein.

The modeling and prediction methods disclosed herein are particularly suited for the analysis of how gene mutations can interact to affect the biological activity of a gene or several genes. Embodiments of the methods and systems of the invention can overcome the problem of the large number of parameters and account for non-normality in the error-structure. For example, in an analysis of how mutations can affect replication capacity (RC) of a virus, there may be several mutations (e.g., x₁, x₂, x₃, . . . xn) for every measured value of replication capacity (y). Also, in certain cases, the variables (e.g., mutations) are not independent of each other, but may have interacting (epistatic) effects.

The methods and systems of the invention may be used with data sets that range from very small (e.g., <100 data points) to very large (e.g., >100,000 data points). Smaller data sets may provide less accurate results, whereas larger data sets may require additional computer capacity.

In some embodiments, the methods and systems of the invention employ generalized kernel ridge regression (GKRR), a regression method which, in essence, penalizes against parameters that have low explanatory power. In certain embodiments, GKRR is used to quantify the fitness effects of amino acid variants using a data set of viral (e.g., HIV) mutations that measures in vitro fitness (e.g., RC) of a virus from a subject. The amino acid sequence of the virus from the subject may be compared to a dataset of virus mutations (e.g., 70,081 HIV-1 samples) obtained from subjects either in the absence of drugs and in the presence of 15 different individual drugs. The samples and or dataset samples may be obtained from subjects (e.g., HIV-1 subtype B infected subjects) undergoing routine drug-resistance testing as described in detail herein. In certain embodiments, the methods disclosed herein offers a quantitative description of a large, realistic and biologically relevant fitness landscape as it relates to mutations in gene sequences. For example, in certain embodiments, the present invention allows the reconstruction of an approximate fitness landscape of the HIV protease (PR) and reverse transcriptase (RT), so as to explain and/or predict how mutations in these proteins affect the overall fitness (e.g., in some cases measured as replication capacity) of an HIV. In one embodiment, and for the examples used herein, the reference HIV is NL4-3.

In some embodiments, the fitness effects that are attributable to individual amino acid variants (main effects) and to pairwise epistatic effects between such variants (interactions) using GKRR are quantified. For example, in one embodiment, in vitro fitnesses of viral isolates may be measured by replicative capacity and compared to the DNA sequence of at least a portion of the HIV RT and/or PR genes. For example, in certain embodiments, amino acids 1 to 99 of PR and 1 to 305 of RT are sequenced. Or, other viruses, genes, and/or non-coding regions may be sequenced.

In some other embodiments, the data may be fit to two alternative models: (i) The ME model, which predicts fitness only on the basis of the Main Effects and (ii) the MEEP model, which predicts fitness using both Main Effects and EPistatic interactions. In certain embodiments, GKRR may be applied because the size of the data-set used is too great for current implementations of other regularization techniques such as the LASSO (Efron et al., Annals of Statistics Vol. 32, pp. 407-499 (2002)) or Dantzig selector (Candes & Tao, Annals of Statistics Vol. 35, pp. 2313-2351 (2007)). Or, other analysis techniques may be used.

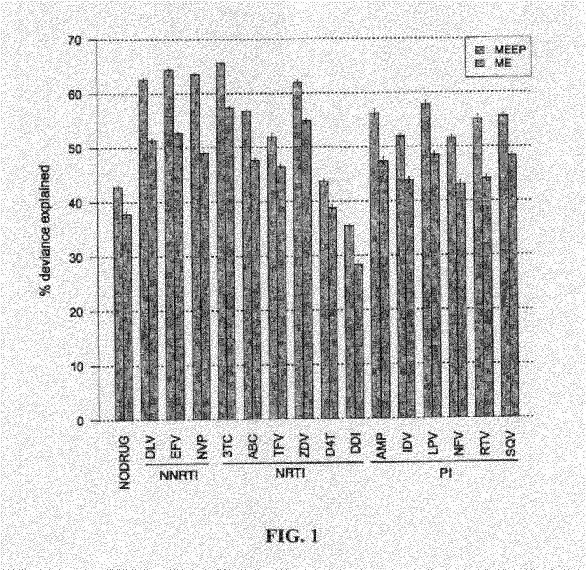

FIG. 1 shows the predictive power of the ME and MEEP models based on a 6-fold cross-validation by randomly subdividing the data set of 70,081 samples into six different training and test sets of about 65,000 and 5,000 independent virus samples, respectively. As is known in the art, the training set is generally larger than the test/validation set. For example, the training set may comprise about 70, 75, 80, 85, 90, or 95% of the total data set, and the test set may comprise, respectively, about 30, 25, 20, 15, 10, or 5% of the total data set. Or, other proportions may be used. The goodness of the fit may be quantified by the percentage deviance explained as described in detail herein. Deviance is generally the standard measure of goodness of fit in generalized models (e.g., in models with non-normal error structure), and is analogous to the R² of linear models with normal error structure (Nelder & Wederburn J. Roy. Stat. Soc. A Vol. 135, pp. 370-384 (1972)). Or, other methods to measure deviance may be used.

The predictive power using MEEP may vary depending upon the dataset used. In certain embodiments, the predictive power of MEEP may be greater than 20%, or greater than 30%, or greater than 35%, or greater than 40%, or greater than 45%, or greater than 50%, or greater than 55%, or greater than 60%, or greater than 65%, or greater than 70%, or greater than 75%, or greater than 80%, or greater than 85%, or greater than 90%, or greater than 95%.

Also, the predictive power using ME may vary depending upon the dataset used. In certain embodiments, the predictive power of ME may be greater than 20%, or greater than 30%, or greater than 35%, or greater than 40%, or greater than 45%, or greater than 50%, or greater than 55%, or greater than 60%, or greater than 65%, or greater than 70%, or greater than 75%, or greater than 80%, or greater than 85%, or greater than 90%, or greater than 95%.

In some embodiments, the predictive power of MEEP is greater than ME. In some embodiments, the improvement in predictive power for MEEP as compared to ME is greater than 5%, or greater than 10%, or greater than 15%, or greater than 20%, or greater than 25%, or greater than 30%, or greater than 35%, or greater than 40%, or greater than 45%, or greater than 50%.

For example, for the dataset used herein, the predictive power across the environments ranges from 35.0% to 65.9% for MEEP and from 26.8% to 57.9% for ME. Also, for the dataset used herein, MEEP has an average predictive power of 54.8% across all 16 environments. Also, for the dataset used herein, MEEP represented on average an 18.3% improvement in predictive power relative to ME.

Generally, in a regularized regression such as GKRR, ah increase in predictive power measured by cross-validation is generally the appropriate model validation method. Hence, the substantial increase in predictive power of the MEEP over the ME model as measured using the methods and systems of the invention validates the inclusion of epistatic terms irrespective of their large number. In certain embodiments, the kernelized approach of the invention allows for inclusion of higher order epistatic interactions without substantial increases in computational requirements. However, including three-way epistasis may marginally decrease predictive power (data not shown). This decrease may be due to the substantial increase in effective coefficients, but does not generally imply that higher order epistatic interactions do not contribute to fitness.

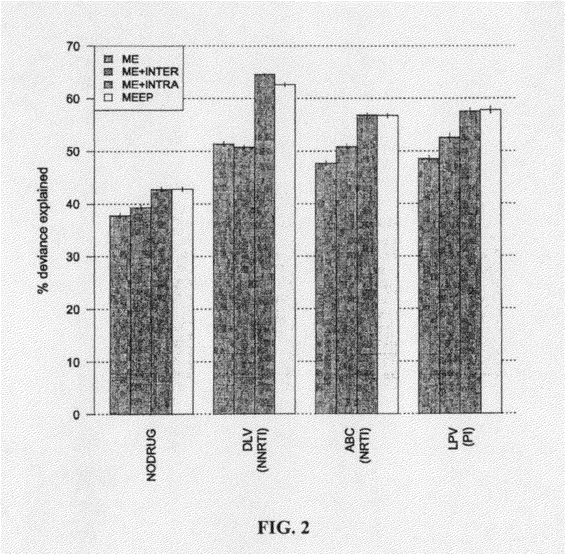

An analogous approach may be taken to investigate the relative role of intragenic (e.g., interactions within PR or RT in HIV) versus intergenic epistasis (e.g., interactions between PR and RT in HIV). For example, as shown herein, four models may be fitted: ME only, ME+intragenic epistasis, ME+intergenic epistasis and the full MEEP model (see FIG. 2). Using the data set described herein, it was found that including intragenic epistasis consistently leads to a much greater gain of predictive power than including intergenic epistasis. The ME+intragenic epistasis model is generally as good, and sometimes even better, than the MEEP model, indicating that in at least certain embodiments, adding intergenic epistatic effects to the ME+intragenic epistasis model does not further improve the predictive power. Decreases in predictive power can, in certain embodiments, be attributable to the fact that adding a large number of unnecessary parameters to a model can result in a reduction in predictive power in GKRR.

Verification that the estimates of the MEEP model are meaningful sequences of PR and RT of treated and untreated subjects were obtained from the Stanford HIV Drug Resistance Database (http://hivdb.stanford.edu; Shafer J. Infect. Dis. 194 Supp. Vol. 1, pp. S51-8 (2006)), and the change of frequency of amino acid variants in treated versus untreated subjects was determined. Using this dataset, it was found that the change of frequency of amino acid variants is significantly correlated with the fitness gain of amino acid variants in presence versus absence of drugs relative to the consensus sequence (p<10⁻¹⁶ and ρ=0.33, Spearman rank, see Examples).

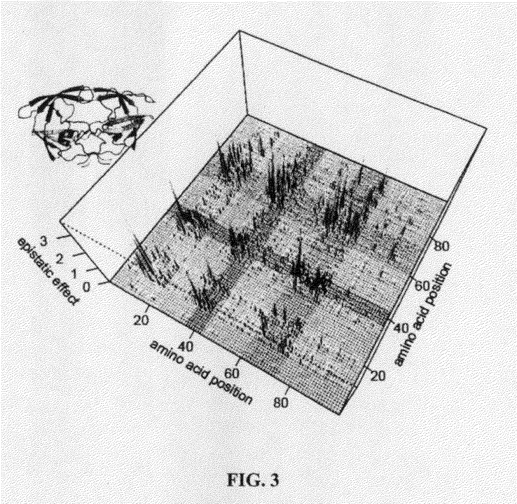

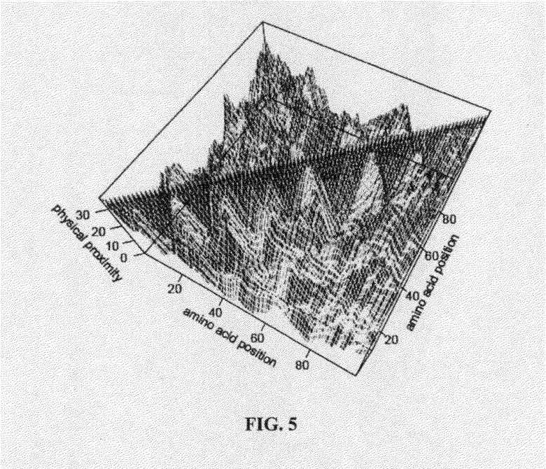

Because protein structure and epistasis are interrelated the relation between epistasis in the drug-free environment and protease structure was investigated as an independent verification that the estimates of the 802,611 epistatic effects are biologically meaningful. FIG. 3 shows the strength of the epistatic effects between amino acid residues of the HIV-1 PR, revealing significant enrichment in epistatic interactions in the flap elbow, the cantilever, and the fulcrum, which are structural units that have previously been described as being important to protein function (Hornak et al. Proc. Nat'l Acad. Sci. Vol. 103, pp. 915-920 (2006)). Bootstrap analysis by random shuffling of the protein sequence reveals that epistasis is significantly enriched both within these structural domains and between the structural domains and the rest of the protein (p<10⁻⁵ for both tests, see the Examples). Moreover, the strength of the epistatic interactions between amino acid residues correlates with physical proximity in 3D structure of PR (p=0.00857 based on 100,000 bootstrap repeats, see FIG. 5 and Methods). The significant correlation between epistasis and secondary structure or proximity demonstrates that the estimated epistatic effects are biologically meaningful. Such correlations could not have been produced artifactually as our procedure includes no structural information for parameter estimation.

Previous studies on epistasis in viruses did not allow a comprehensive quantification of individual fitness effects and epistatic interactions, because they focused either on a limited set of interactions, made use of sequence data only, or did not correct for the effect of the genetic background (see, e.g., Sanjuan et al. Proc. Nat'l Acad. Sci. Vol. 101, pp. 15376-15379 (2004); Chen et al. J. Virol. Vol. 78, pp. 3722-3732 (2004); and Provine, THE ORIGINS OF THEORETICAL POPULATION GENETICS (1971). The methods and systems of the invention recognize that despite the combinatorial complexity of the problem, biologically meaningful estimates for main effects and epistatic interactions can be obtained from large data sets that link fitness measurements to genotype.

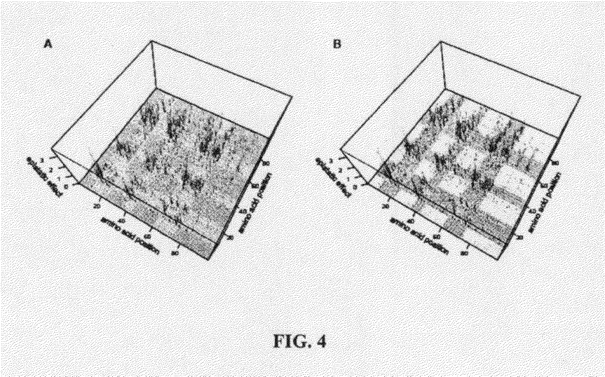

The estimated epistatic effects were verified using independent data. First, as shown in FIG. 2, it was shown that for the samples in the HIV data set, models including epistatic interactions explain on average 54.8% of the deviance in fitness across the 16 different environments (e.g., no drug, non-nucleoside reverse transcriptase inhibitor (NNRTI), nucleoside reverse transcriptase inhibitor (NRTI), and protease inhibitor (PI) each evaluated for the ME, ME+intergenic interaction, ME+intragenic interaction, and MEEP) based on six-fold cross-validation. Second, a highly significant correlation was found between the change of the estimated main effects in the presence versus the absence of drugs, and the change in frequency of the corresponding amino acid variants in treated versus untreated subjects based on independent data from the Stanford HIV drug resistance database (http://hivdb.stanford.edu). Finally, a correlation between epistasis and PR structural domains or physical proximity in the 3D structure of PR was shown (see FIGS. 3-5).

For the data set described herein, the inclusion of epistatic interactions improves the predictive power by an average of 18.7% across all environments. Thus, the methods and systems of the invention can provide a predictive models for realistic fitness landscapes, opening up new avenues to study evolutionary adaptation on complex fitness landscapes and to simulate the evolution of drug resistance.

### Ridge Regression

In some embodiments, ridge regression is used to estimate the effects of individual mutations in the at least one gene for the subject. Ridge regression is a statistical method that can be used for parameter estimation in situations where overfitting is a problem, as in the example discussed herein where the number of fitted parameters (e.g., mutation sites in a gene) exceeds the number of data points (e.g., measure of gene activity or other biological effect such as replication capacity). Ridge regression estimates parameters by minimizing the following penalty function,

$$𝒫 = {\sum }_{i} {( {y}_{i} - {\sum }_{j} {φ}_{j} {x}_{ij} )}^{2} + λ {\sum }_{k} {φ}_{k}^{2} \qquad ( 1 )$$

where yᵢ is the value of the response variable for the i^{th} data point, φⱼ is the coefficient of the j^{th} explanatory variable, xᵢⱼ is a binary variable accounting for the presence or absence of this explanatory variable in the i^{th} data point, and λ is the so-called regularization parameter.

The first term represents the sum of the squared residuals. This term corresponds exactly to the penalty function of standard multiple linear regression and its minimization requires to find that combination of coefficients for which the sum of squared residuals is smallest. The second term represents the sum of the squares of all coefficients and is multiplied by λ to control the relative weight of the first and second term. The second term is minimized for vanishing coefficients φⱼ. Hence, by minimizing both terms simultaneously, ridge regression tends to penalize for large coefficients unless they contribute substantially to reducing the residuals. The relative importance of reducing the residuals versus decreasing the magnitude of the coefficients is controlled by the regularization parameter λ. The value of λ for which the model best predicts the data is determined iteratively by cross-validation.

Kernel ridge regression (KRR) is an efficient computational implementation for ridge regressions with a greater number of (effective) dimensions than data-points. Just as a generalized linear model (GLM) is an extension of linear models in order to account for the non-normality of the error structure, a generalized kernel ridge regression (GKRR) extends standard KRR to account for non-normal error structure. GKRR applies the same procedure as GLM, but replaces the weighted least squares regression with a weighted KRR. Similar to the Iteratively Re-weighted Least Squares (IRWLS) in GLM, the GKRR is based on an algorithm of Iteratively Re-Weighted KRR.

### Iterative Re-Weighting for Generalized Ridge Regression

Like GLM, a generalized ridge regression is characterized by (i) a linear predictor, which is ridge regression, (ii) a non-linear link function, g (in this study g=log), and (iii) an error structure V, which defines the estimated variance of a given data point. The ridge regression has two functions, RR^{solve} and RR^{predict}. The first function is used to determine the coefficients φ given the data X and y. Specifically,

φ=RR^{solve}(X,z,w) (2)

where z=g(y) and w is a vector giving the weight of each data point. The function RR^{predict} gives the prediction given a data set X and coefficients φ and is thus given by

η=RR^{predict}(X,φ) (3)

where η is vector of the predicted linear values.

Next initializing w and z to wₒ=1 and zₒ=g(y) is done. With this initialization, the following expression is obtained:

φ₀=RR^{solve}(X,z₀,w₀) (4)

Hence

η₀=RR^{predict}(X,φ₀) (5)

From the η the expected value and variance of the results are given by

μ₀=g⁻¹(η₀) (6)

V₀=h(η₀) (7)

The next iterate z₁ as can now be calculated as

$${z}_{1} = {η}_{0} + ( y - {μ}_{0} ) \frac{\partial {η}_{0}}{\partial {μ}_{0}} \qquad ( 8 )$$

and then determine a set of weighting terms w₁ given by

$${w}_{1} = {( \frac{\partial {μ}_{0}}{\partial {η}_{0}} )}^{2} \frac{1}{{V}_{0}} \qquad ( 9 )$$

From hereon the procedure is iterated by calculating the next iterate φᵢ as per equation 4 above. The goodness of the fit at each iteration is evaluated by the deviance (as described in more detail herein). The iteration terminates when the internal deviance is no longer reduced by further iteration. Like in a GLM, the measure of goodness of a fit in a generalized ridge regression is the deviance. The definition of deviance is given by the difference between the log-likelihoods of the given model and a saturated model (multiplied by −2). The given model is the model with the estimated parameters and the saturated model is a model that fits the data perfectly.

If the error structure is normal as is assumed in standard regression, then the deviance computed according to the above definition equals the R² of a standard regression. In this particular embodiment, as the link function g is given by the logarithm, the error structure is Poisson. Hence g⁻¹ and h are both given by the exponential function such that Vᵢ=μᵢ. The deviance for a Poisson error structure is given by

$$D = 2 {\sum }_{i = 0}^{N} {y}_{i} log ( {y}_{i} / {μ}_{i} ) - ( {y}_{i} - {μ}_{i} ) \qquad ( 10 )$$

where N is the number of data points.

### Weighted Ridge Regression

Provided herein are the equations for weighted ridge regression by extending derivations in Christianini, AN INTRODUCTION INTO SUPPORT VECTOR MACHINES (2000). In this section, the standard notation and terminology is used. Further explanation of KRR is provided in the art, as for example, chapter 6 in Christianini (cited above) The penalty function is a logical extension of the unweighted penalty function by the inclusion of a weighting vector w. The corresponding procedure is:

$$\begin{matrix}minimize & {λφ}^{T} φ + {ξ}^{T} W ξ \\ subject to & y - X φ = ξ \\ & \sum w = 1 \\ where & {W}_{ij} = \{ \begin{matrix}{w}_{i} \vert i = j \\ 0 \vert i \neq j\end{matrix}\end{matrix} \qquad ( 11 )$$

where φ is the vector of coefficients and ξ the residuals, referred to as “slack variables” in the ridge regression literature.

Using vector notation, the Lagrangian formulation for minimization under constraints is then given by

L(w,ξ,φ,α,λ)=λφ^{T}φ+ξ^{T}Wξ+α^{T}(y−Xφ−ξ) (12)

where a is the vector of Lagrangian coefficients.
Taking the partial derivatives and applying stationarity gives the equalities

$$\begin{matrix}φ = \frac{{X}^{T} α}{2 λ} \\ and & ( 13 ) \\ ξ = \frac{α}{2 w} & ( 14 )\end{matrix}$$

Back-substituting equations 13 and 14 into equation 12 yields the so-called dual problem:

$$maximize W ( α ) = {α}^{T} y - \frac{{α}^{T} {XX}^{T} α}{4 λ} - \frac{1}{4} {α}^{T} ( \frac{α}{w} ) \qquad ( 15 )$$

### Weighted Kernel Ridge Regression

In some cases, the data matrix X can be seen as a projection of another matrix Z into higher φ dimensional space, called feature space. This projection into feature space is very memory intensive if the dimensionality of feature space is high. It is possible to then represent this projection as xᵢ=ƒ(zᵢ), where zᵢ and xi are individual vectors for data point i. The matrix XX^{T}=K can be computed directly from Z

as Kᵢⱼ=xᵢ^{T}xⱼ

thus Kᵢⱼ=ƒ(zᵢ)^{T}ƒ(zⱼ) (16)

The computation of K, referred to as the kernel matrix, is further simplified if the composite function ƒ^{T} ƒ can calculated as a single function g, in which case

Kᵢⱼ=g(zᵢ,zⱼ) (17)

In this way the kernel matrix is computable without the costly projection into feature space. Following equation 15, XX^{T} is replaced with the kernel matrix K to obtain

$$W ( α ) = {α}^{T} y - \frac{{α}^{T} K α}{4 λ} - \frac{1}{4} {α}^{T} ( \frac{α}{w} ) \qquad ( 18 )$$

Taking the derivative in α and applying stationarity gives

$$o = y - \frac{1}{2 λ} K α - \frac{α}{2 w} \qquad ( 19 )$$

Solving for α we obtain

$$α = 2 {λ ( K + \frac{λ}{w} )}^{- 1} y \qquad ( 20 )$$

To use the derived coefficients to predict a value for a previously unseen example zᵤ, the following calculation is applied:

$${y}_{u}^{*} = \frac{{X}^{T} α}{2 λ} f ( {z}_{u} ) \qquad ( 21 )$$

### Estimation of λ

Because the relation between predictive power and lambda is convex, a simple bisection algorithm can be used to calculate the λ coefficient.
1. The training set is divided into two components: 90% of the set is put into λ-training set and 10% into a test set.
2. The value of λ is initialized to 0.1 and a “step” parameter (dλ) to 0.05.
3. The model is trained on λ, λ−dλ and λ+dλ.
4. Each model is tested on the test set and λ is updated to the value which gives the lowest deviance.
5. dλ is halved and the bisection algorithm returns to step 3.
6. After N steps, the algorithm is terminated and the current value of λ is output.

Due to the iterative re-weighting algorithm used in the GKRR, it can be computationally too expensive to calculate the cross-validation with 2 GKRRs for each iteration of the bisection algorithm. For this reason, an approximation of the GKRR may be used instead. It was discovered empirically that the full model (with it's Poisson error structure) could be approximated well with the model

\sqrt{Wᵢ}=φ^{T}xᵢ+xᵢ^{T}ψxᵢ (22)

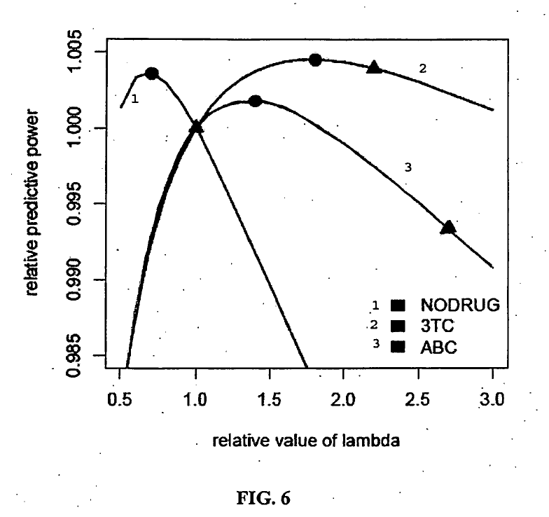

FIG. 6 shows that using the square root approximation to estimate λ results in a small error (<1%) as measured by predictive power.

### The Virus and Viral Samples

As noted herein, a mutation can be present in any type of virus, for example, any virus found in animals. In some embodiment of the invention, the virus includes viruses known to infect mammals, including dogs, cats, horses, sheep, cows etc. In some embodiments, the virus is known to infect primates. In some such embodiments, the virus is known to infect humans. Examples of human viruses include, but are not limited to, human immunodeficiency virus (“HIV”), herpes simplex virus, cytomegalovirus virus, varicella zoster virus, other human herpes viruses, influenza A virus, respiratory syncytial virus, hepatitis A, B and C viruses, rhinovirus, and human papilloma virus. In some embodiments of the invention, the virus is HIV. Preferably, the virus is human immunodeficiency virus type 1 (“HIV-1”). The foregoing are representative of certain viruses for which there is presently available anti-viral chemotherapy and represent the viral families retroviridae, herpesviridae, orthomyxoviridae, paramxyxovirus, picomavirus, flavivirus, pneumovirus and hepadnaviridae. This invention can be used with other viral infections due to other viruses within these families as well as viral infections arising from viruses in other viral families for which there is or there is not a currently available therapy.

A mutation associated with a change in biological activity (e.g., resistance or a decrease in replication capacity) according to the present invention can be found in a viral sample obtained by any means known in the art for obtaining viral samples. Such methods include, but are not limited to, obtaining a viral sample from a human or an animal infected with the virus or obtaining a viral sample from a viral culture. In one embodiment, the viral sample is obtained from a human individual infected with the virus. The viral sample could be obtained from any part of the infected individual's body or any secretion expected to contain the virus. Examples of such parts include, but are not limited to blood, serum, plasma, sputum, lymphatic fluid, semen, vaginal mucus and samples of other bodily fluids. In one embodiment, the sample is a blood, serum or plasma sample.

In other embodiments, a mutation associated with a change in biological activity according to the present invention is present in a virus that can be obtained from a culture. In some embodiments, the culture can be obtained from a laboratory. In other embodiments, the culture can be obtained from a collection, for example, the American Type Culture Collection.

In some embodiments, a mutation associated with a change in biological activity according to the present invention is present in a derivative of a virus. In one embodiment, the derivative of the virus is not itself pathogenic. In another embodiment, the derivative of the virus is a plasmid-based system, wherein replication of the plasmid or of a cell transfected with the plasmid is affected by the presence or absence of the selective pressure, such that mutations are selected that increase resistance to the selective pressure. In some embodiments, the derivative of the virus comprises the nucleic acids or proteins of interest, for example, those nucleic acids or proteins to be targeted by an anti-viral treatment. In one embodiment, the genes of interest can be incorporated into a vector. See, e.g., U.S. Pat. Nos. 5,837,464 and 6,242,187, and PCT publication WO 99/67427, each of which is incorporated herein by reference. In one embodiment, the genes are those that encode for a protease or reverse transcriptase.

In another embodiment, the intact virus need not be used. Instead, a part of the virus incorporated into a vector can be used. Preferably that part of the virus is used that is targeted by an anti-viral drug.

In another embodiment, a mutation associated with a change in biological activity is present in a genetically modified virus. The virus can be genetically modified using any method known in the art for genetically modifying a virus. For example, the virus can be grown for a desired number of generations in a laboratory culture. In one embodiment, no selective pressure is applied (e.g., the virus is not subjected to a treatment that favors the replication of viruses with certain characteristics), and new mutations accumulate through random genetic drift. In another embodiment, a selective pressure is applied to the virus as it is grown in culture (e.g., the virus is grown under conditions that favor the replication of viruses having one or more characteristics). In one embodiment, the selective pressure is an anti-viral treatment. Any known anti-viral treatment can be used as the selective pressure. In one embodiment, the virus is HIV and the selective pressure is a protease inhibitor. In another embodiment, the virus is HIV-1 and the selective pressure is protease inhibitor. Any protease inhibitor can be used to apply the selective pressure. Examples of protease inhibitors include, but are not limited to, saquinavir, ritonavir, indinavir, nelfinavir, amprenavir and lopinavir. In one embodiment, the protease inhibitor is selected from a group consisting of saquinavir, ritonavir, indinavir, nelfinavir, amprenavir and lopinavir. In another embodiment, the protease inhibitor is amprenavir. By treating HIV cultured in vitro with a protease inhibitor, e.g., amprenavir, one can select for mutant strains of HIV that have an increased resistance to amprenavir. The stringency of the selective pressure can be manipulated to increase or decrease the survival of viruses not having the selected-for characteristic.

In another aspect, a mutation associated with a change in biological activity according to the present invention is made by mutagenizing a virus, a viral genome, or a part of a viral genome. Any method of mutagenesis known in the art can be used for this purpose. In one embodiment, the mutagenesis is essentially random. In another embodiment, the essentially random mutagenesis is performed by exposing the virus, viral genome or part of the viral genome to a mutagenic treatment. In another embodiment, a gene that encodes a viral protein that is the target of an anti-viral therapy is mutagenized. Examples of essentially random mutagenic treatments include, for example, exposure to mutagenic substances (e.g., ethidium bromide, ethylmethanesulphonate, ethyl nitroso urea (ENU)) radiation (e.g., ultraviolet light), the insertion and/or removal of transposable elements (e.g., Tn5, Tn10), or replication in a cell, cell extract, or in vitro replication system that has an increased rate of mutagenesis. See, e.g., Russell et al., Proc. Nat. Acad. Sci. Vol. 76, pp. 5918-5922 (1979); Russell, ENVIRONMENTAL MUTAGENS AND CARCINOGENS: PROCEEDINGS OF THE THIRD INTERNATIONAL CONFERENCE ON ENVIRONMENTAL MUTAGENS (1982). One of skill in the art will appreciate that while each of these methods of mutagenesis is essentially random, at a molecular level, each has its own preferred targets.

In another aspect, a mutation that might affect the sensitivity of a virus to an anti-viral therapy is made using site-directed mutagenesis. Any method of site-directed mutagenesis known in the art can be used. See, e.g., Sambrook et al., MOLECULAR CLONING: A LABORATORY MANUAL, COLD SPRING HARBOR LABORATORY, (3.sup.rd ed., 2001); and Ausubel et al., CURRENT PROTOCOLS IN MOLECULAR BIOLOGY (1989). The site directed mutagenesis can be directed to, e.g., a particular gene or genomic region, a particular part of a gene or genomic region, or one or a few particular nucleotides within a gene or genomic region. In one embodiment, the site directed mutagenesis is directed to a viral genomic region, gene, gene fragment, or nucleotide based on one or more criteria.

In some embodiments, a gene or a portion of a gene is subjected to site-directed mutagenesis because it encodes a protein that is known or suspected to be a target of an anti-viral therapy, e.g., the gene encoding the HIV protease. In another embodiment, a portion of a gene, or one or a few nucleotides within a gene, are selected for site-directed mutagenesis. In one embodiment, the nucleotides to be mutagenized encode amino acid residues that are known or suspected to interact with an anti-viral compound. In another embodiment, the nucleotides to be mutagenized encode amino acid residues that are known or suspected to be mutated in viral strains having decreased susceptibility to the anti-viral treatment. In another embodiment, the mutagenized nucleotides encode amino acid residues that are adjacent to or near in the primary sequence of the protein residues known or suspected to interact with an anti-viral compound or known or suspected to be mutated in viral strains having decreased susceptibility to an anti-viral treatment. In another embodiment, the mutagenized nucleotides encode amino acid residues that are adjacent to or near to in the secondary, tertiary or quaternary structure of the protein residues known or suspected to interact with an anti-viral compound or known or suspected to be mutated in viral strains having decreased susceptibility to an anti-viral treatment. In another embodiment, the mutagenized nucleotides encode amino acid residues in or near the active site of a protein that is known or suspected to bind to an anti-viral compound. See, e.g., Sarkar and Sommer, Biotechniques, Vol. 8, pp. 404-407 (1990).

### Detecting the Presence or Absence of Mutations in a Virus

The presence or absence of a mutation associated with a change in biological activity according to the present invention in a virus can be detected by any means known in the art for detecting a mutation. The mutation can be detected in the viral gene that encodes a particular protein, or in the protein itself, e.g., in the amino acid sequence of the protein.

In some embodiments, the mutation is in the viral genome. Such a mutation can be in, for example, a gene encoding a viral protein, in a cis or trans acting regulatory sequence of a gene encoding a viral protein, an intergenic sequence, or an intron sequence. The mutation can affect any aspect of the structure, function, replication or environment of the virus that changes its susceptibility to an anti-viral treatment. In one embodiment, the mutation is in a gene encoding a viral protein that is the target of an anti-viral treatment.

A mutation within a viral gene can be detected by utilizing a number of techniques. Viral DNA or RNA can be used as the starting point for such assay techniques, and may be isolated according to standard procedures which are well known to those of skill in the art.

The detection of a mutation in specific nucleic acid sequences, such as in a particular region of a viral gene, can be accomplished by a variety of methods including, but not limited to, restriction-fragment-length-polymorphism detection based on allele-specific restriction-endonuclease cleavage, mismatch-repair detection, binding of MutS protein, denaturing-gradient gel electrophoresis, single-strand-conformation-polymorphism detection, RNAase cleavage at mismatched base-pairs, chemical or enzymatic cleavage of heteroduplex DNA, methods based on oligonucleotide-specific primer extension, genetic bit analysis, oligonucleotide-ligation assay, oligonucleotide-specific ligation chain reaction (“LCR”), gap-LCR, radioactive or fluorescent DNA sequencing using standard procedures well known in the art, and peptide nucleic acid (PNA) assays.

In addition, viral DNA or RNA may be used in hybridization or amplification assays to detect abnormalities involving gene structure, including point mutations, insertions, deletions and genomic rearrangements. Such assays may include, but are not limited to, Southern analyses, single stranded conformational polymorphism analyses (SSCP), and PCR analyses.

Such diagnostic methods for the detection of a gene-specific mutation can involve for example, contacting and incubating the viral nucleic acids with one or more labeled nucleic acid reagents including recombinant DNA molecules, cloned genes or degenerate variants thereof, under conditions favorable for the specific annealing of these reagents to their complementary sequences. Preferably, the lengths of these nucleic acid reagents are at least 15 to 30 nucleotides. After incubation, all non-annealed nucleic acids are removed from the nucleic acid molecule hybrid. The presence of nucleic acids which have hybridized, if any such molecules exist, is then detected. Using such a detection scheme, the nucleic acid from the virus can be immobilized, for example, to a solid support such as a membrane, or a plastic surface such as that on a microtiter plate or polystyrene beads. In this case, after incubation, non-annealed, labeled nucleic acid reagents of the type described above are easily removed. Detection of the remaining, annealed, labeled nucleic acid reagents is accomplished using standard techniques well-known to those in the art. The gene sequences to which the nucleic acid reagents have annealed can be compared to the annealing pattern expected from a normal gene sequence in order to determine whether a gene mutation is present.

Alternative diagnostic methods for the detection of gene specific nucleic acid molecules may involve their amplification, e.g., by PCR, followed by the detection of the amplified molecules using techniques well known to those of skill in the art. The resulting amplified sequences can be compared to those which would be expected if the nucleic acid being amplified contained only normal copies of the respective gene in order to determine whether a gene mutation exists.

Additionally, the nucleic acid can be sequenced by any sequencing method known in the art. For example, the viral DNA can be sequenced by the dideoxy method of Sanger et al., Proc. Natl. Acad. Sci. Vol. 74, pp. 5463 (1977), as further described by Messing et al., Nuc. Acids Res. Vol. 9, p. 309 (1981), or by the method of Maxam et al., Methods in Enzymology Vol. 65, p. 499 (1980). See also the techniques described in Sambrook et al., MOLECULAR CLONING: A LABORATORY MANUAL, COLD SPRING HARBOR LABORATORY (3.sup.rd ed., 2001); and Ausubel et al., CURRENT PROTOCOLS IN MOLECULAR BIOLOGY (1989).

Antibodies directed against the viral gene products, e.g., viral proteins or viral peptide fragments can also be used to detect mutations in the viral proteins. Alternatively, the viral protein or peptide fragments of interest can be sequenced by any sequencing method known in the art in order to yield the amino acid sequence of the protein of interest. An example of such a method is the Edman degradation method which can be used to sequence small proteins or polypeptides. Larger proteins can be initially cleaved by chemical or enzymatic reagents known in the art, for example, cyanogen bromide, hydroxylamine, trypsin or chymotrypsin, and then sequenced by the Edman degradation method.

### Measuring Phenotypic Susceptibility of a Mutant Virus

Any method known in the art can be used to determine the phenotypic susceptibility of a mutant virus or population of viruses to an anti-viral therapy. See e.g., U.S. Pat. Nos. 5,837,464 and 6,242,187, incorporated herein by reference in their entireties. In some embodiments a phenotypic analysis is performed, e.g., the susceptibility of the virus to a given anti-viral agent is assayed with respect to the susceptibility of a reference virus without the mutations. This is a direct, quantitative measure of drug susceptibility and can be performed by any method known in the art to determine the susceptibility of a virus to an anti-viral agent. An example of such methods includes, but is not limited to, determining the fold change in IC50 values with respect to a reference virus. Phenotypic testing measures the ability of a specific viral strain to grow in vitro in the presence of a drug inhibitor. A virus is less susceptible to a particular drug when more of the drug is required to inhibit viral activity, versus the amount of drug required to inhibit the reference virus.

A phenotypic analysis may used to calculate the ability of a drug to inhibit the replication capacity a viral strain. The results of the analysis can also be presented as fold for each viral strain as compared with a drug-susceptible control strain or a prior viral strain from the same subject. Because the virus is directly exposed to each of the available anti-viral medications, results can be directly linked to treatment response. For example, if the subject virus shows resistance to a particular drug, that drug is avoided or omitted from the subject's treatment regimen, allowing the physician to design a treatment plan that is more likely to be effective for a longer period of time.

In another embodiment, the phenotypic analysis is performed using recombinant virus assays (“RVAs”). RVAs use virus stocks generated by homologous recombination between viral vectors and viral gene sequences, amplified from the subject virus. In some embodiments, the viral vector is a HIV vector and the viral gene sequences are protease and/or reverse transcriptase sequences.

In a some embodiments, the phenotypic analysis is performed using PHENOSENSE (ViroLogic Inc., South San Francisco, Calif.). See Petropoulos et al., Antimicrob. Agents Chemother. Vol. 44, pp. 920-928 (2000); U.S. Pat. Nos. 5,837,464 and 6,242,187. PHENOSENSE is a phenotypic assay that achieves the benefits of phenotypic testing and overcomes the drawbacks of previous assays. Because the assay has been automated, PHENOSENSE offers higher throughput under controlled conditions. The result is an assay that accurately defines the susceptibility profile of a subject's HIV isolates to all currently available antiretroviral drugs, and delivers results directly to the physician within about 10 to about 15 days of sample receipt. PHENOSENSE is accurate and can obtain results with only one round of viral replication, thereby avoiding selection of subpopulations of virus. The results are quantitative, measuring varying degrees of drug susceptibility, and sensitive—the test can be performed on blood specimens with a viral load of about 500 copies/mL and can detect minority populations of some drug-resistant virus at concentrations of 10% or less of total viral population. Furthermore, the results are reproducible and can vary by less than about 1.4-2.5 fold, depending on the drug, in about 95% of the assays performed.

PHENOSENSE can be used with nucleic acids from amplified viral gene sequences. As discussed herein, the sample containing the virus may be a sample from a human or an animal infected with the virus or a sample from a culture of viral cells. In one embodiment, the viral sample comprises a genetically modified laboratory strain.

A resistance test vector (“RTV”) can then be constructed by incorporating the amplified viral gene sequences into a replication defective viral vector by using any method known in the art of incorporating gene sequences into a vector. In one embodiment, restrictions enzymes and conventional cloning methods are used. See Sambrook et al., MOLECULAR CLONING: A LABORATORY MANUAL, COLD SPRING HARBOR LABORATORY, (3.sup.rd ed., 2001); and Ausubel et al., CURRENT PROTOCOLS IN MOLECULAR BIOLOGY (1989). In a some embodiments, ApaI and PinAI restriction enzymes are used. Preferably, the replication defective viral vector is the indicator gene viral vector (“IGVV”). In some embodiments, the viral vector contains a means for detecting replication of the RTV. Preferably, the viral vector contains a luciferase expression cassette.

The assay can be performed by first co-transfecting host cells with RTV DNA and a plasmid that expresses the envelope proteins of another retrovirus, for example, amphotropic murine leukemia virus (MLV). Following transfection, virus particles can be harvested and used to infect fresh target cells. The completion of a single round of viral replication can be detected by the means for detecting replication contained in the vector. In some embodiments, the completion of a single round of viral replication results in the production of luciferase. Serial concentrations of anti-viral agents can be added at either the transfection step or the infection step.

Susceptibility to the anti-viral agent can be measured by comparing the replication of the vector in the presence and absence of the anti-viral agent. For example, susceptibility to the anti-viral agent can be measured by comparing the luciferase activity in the presence and absence of the anti-viral agent. Susceptible viruses would produce low levels of luciferase activity in the presence of antiviral agents, whereas viruses with reduced susceptibility would produce higher levels of luciferase activity.

In some embodiments, PHENOSENSE is used in evaluating the phenotypic susceptibility of HIV-1 to anti-viral drugs. Preferably, the anti-viral drug is a protease inhibitor. More preferably, it is amprenavir, or one of the other viral agents described herein. In some embodiments, the reference viral strain is HIV strain NL4-3 or HXB-2.

In one embodiment, viral nucleic acid, for example, HIV-1 RNA is extracted from plasma samples, and a fragment of, or entire viral genes could be amplified by methods such as, but not limited to PCR. See, e.g., Hertogs et al., Antimicrob Agents Chemother Vol. 42, pp. 269-76 (1998). In one example, a 2.2-kb fragment containing the entire HIV-1 PR- and RT-coding sequence is amplified by nested reverse transcription-PCR. The pool of amplified nucleic acid, for example, the PR-RT-coding sequences, is then cotransfected into a host cell such as CD4+ T lymphocytes (MT4) with the pGEMT3deltaPRT plasmid from which most of the PR (codons 10 to 99) and RT (codons 1 to 482) sequences are deleted. Homologous recombination leads to the generation of chimeric viruses containing viral coding sequences, such as the PR- and RT-coding sequences derived from HIV-1 RNA in plasma. The susceptibilities of the chimeric viruses to all currently available anti-viral agents targeting the products of the transfected genes (proRT and/or PR inhibitors, for example), can be determined by any cell viability assay known in the art. For example, an MT4 cell-3-(4,5-dimethylthiazol-2-yl)-2,5-diphenyltetrazolium bromide-based cell viability assay can be used in an automated system that allows high sample throughput. The profile of resistance to all the anti-viral agents, such as the RT and PR inhibitors can be displayed graphically in a single PR-RT-Antivirogram.

Other assays for evaluating the phenotypic susceptibility of a virus to anti-viral drugs known to one of skill in the art can be used. See, e.g., Shi and Mellors, Antimicrob Agents Chemother. Vol. 41, pp. 2781-85 (1997); Gervaix et al., Proc Natl Acad Sci Vol. 94, pp. 4653-58 (1997); Race et al., AIDS Vol. 13, pp. 2061-2068 (1999), incorporated herein by reference in their entireties.

In another embodiment, the susceptibility of a virus to treatment with an anti-viral treatment is determined by assaying the activity of the target of the anti-viral treatment in the presence of the anti-viral treatment. In one embodiment, the virus is HIV, the anti-viral treatment is a protease inhibitor, and the target of the anti-viral treatment is the HIV protease. See, e.g., U.S. Pat. Nos. 5,436,131, 6,103,462, incorporated herein by reference in their entireties.

### Application of the Method to the Analysis of HIV Replicative Capacity

### 1. Database

For this study, 70,081 virus samples from HIV-1 subtype B infected subjects undergoing routine drug-resistance testing were obtained. The samples were assayed for replicative capacity as determined using HIV derived test vectors. The assay to measure viral replicative capacity in absence of drugs has been described in detail elsewhere (Petropoulos et al. Antimicrobial Agents and Chemotherapy Vol. 44, pp. 920-28 (2000)). In brief, subject virus-derived amplicons representing all of the protease (PR) gene and most of reverse transcriptase (RT) gene are inserted into the backbone of a resistance test vector. This vector is based on the NL4-3 molecular HIV clone and has been modified such that it can only undergo a single round of replication. The replicative capacity assay then quantifies the total production of infectious progeny virus after a single round of infection of the subject-derived virus relative to that of an NL4-3 based control virus. The replicative capacity of the NL4-3 based control virus thus equals 1.0. The replicative capacity measures the total reproductive output relative to a control virus in a single round of replication and can thus be regarded as a proxy for viral fitness (Dykes & Demeter, Clin. Microbiol. Rev. Vol. 20, pp. 550-78 (2007)).

Commonly, the replicative capacity is measured in the absence of drugs. For the virus samples analyzed here, the replicative capacity was also measured in the presence of 15 different single drugs at a series of drug dilutions. The drugs used were as follows: (A) the protease inhibitors (PI) amprenavir (AMP), indinavir (IDV), lopinavir (LPV), nelfinavir (NFV), ritonavir (RTV), and saquinavir (SQV); (B) the nucleoside reverse transcriptase inhibitors (NRTI) abacavir (ABC), didanosine (ddI), lamivudine (3TC), stavudine (d4T), zidovudine (ZDV), and tenofovir (TFV); and (C) the non-nucleoside reverse transcriptase inhibitors (NNRTI) delavirdine (DLV), efavirenz (EFV), and nevirapine (NVP). For each drug, the replicative capacity of a virus on drugs was given by the interpolated value measured at the drug concentration at which the NL4-3 based control virus has 10% of its replicative capacity in the absence of drug (i.e. the IC90 for NL4-3 is used as the reference drug concentration for every subsequent measurement). In addition to the fitness measurement on and off drugs, the protein sequence encoding for all of PR and the amino acids 1 to 305 of RT were sequenced by population sequencing for all virus samples included in this analysis.

To estimate parameters, 65,000 randomly chosen samples (e.g., amino acid sequences with corresponding replicative capacity measurements on and off drugs) were selected and the remaining 5,000 samples were retained for the purpose of cross-validation. To compare the estimated fitness effects of mutations with their change in frequency in treated versus untreated subjects, an independent set of sequences obtained from the Stanford HIV Drug Resistance Database (http://hivdb.stanford.edu; Shafer J. Infect. Dis. 194 Supp. Vol. 1, pp. S51-8 (2006)) consisting of 24,865 protease sequences (10,011 treated; 14,854 untreated) and 19,254 RT sequences (7,232 treated; 12,022 untreated) were used.

To interpret the estimated epistatic effects in the light of the structure of the HIV protease the positions of the alpha carbons of each amino acid residue of the entry 1A30 (PDB ID) (Louis et al. Biochemistry Vol. 37, pp. 2105-2110 (1998)) of the Protein Data Bank were used. The physical proximity between amino acid residues in the protease as the maximal physical distance (between any pair of residues in the protease) minus the physical distance of the pair of residues under consideration was then calculated. Because the protease is a homodimer, these calculations result in two values for the physical distance between any pair of residues. One value corresponds to the distance between the two amino acid residues within a single monomer, and the other corresponds to the distance between the amino acid residues residing on two different monomers. To calculate physical proximity the smaller of the two physical distances was used. Physical proximity is measured in Å. Then, the strength of the interactions correlates with physical proximity in the HIV-1 protease (see FIG. 5) is tested.

It is important to note that replication capacity (RC) is different from IC50 and EC50, other commonly used phenotypic measures of drug resistance which measure the drug concentration at which a virus sample is half maximally inhibited. Previous algorithms to predict phenotypic properties of drug resistance have focused on the prediction of IC50 (Rhee, Soo-Yon et al. Proc. Natl. Acad. Sci. Vol. 103, pp. 17355-60 (2006)). By measuring a drug concentration that causes a relative change in activity, IC50 discards information about the absolute fitness. RC, however, does not measure a change in activity but an absolute activity at a given drug concentration (previously measured as the IC90 of the reference NL4-3). RC, therefore, is a more appropriate measure of viral fitness. However, because RC measures absolute activity it is a more complex phenotypic measure and therefore harder to predict. To verify that the RC is a more appropriate measure of viral fitness, the method of the invention was tested against a measure similar to IC50, defined by RC in presence of drugs relative to the corresponding RC in absence of drugs. This simpler fitness resulted in an average predictive power of 89%, and a maximum predictive power of 95%, across all the drug environments.

### 2. Application of the Methods of the Invention to HIV Data

In certain embodiments, the methods of the present invention may be used to correlate mutations in a gene or several genes to biological activity of those genes. For example, in certain embodiments, the methods of the present invention may be used to correlate mutations in HIV-1 to replicative capacity. In one embodiment, mutations in the HIV reverse transcriptase (RT) and/or protease (PR) are evaluated.

a. Model

In certain embodiments, the methods and systems of the invention estimate the fitness effects of individual mutations in isolation (main effects) and the fitness effects resulting from pairwise epistasis between these mutations (interactions). In order to estimate the effects of mutations without reference to an arbitrary “wild-type” an effect for each amino acid variant at each locus was fitted. To ease computational issues, the fitting did not include any mutation that appeared fewer than 10 times in the entire data-set. The effect of this thresholding on predictive power was less than 0.01%. For the HIV study, there were N_{M}=1,859 amino acid variants above the threshold and N_{E}=802,611 pairwise combinations of these variants. To estimate main effects and interactions the following model was used:

$$log ( {W}_{i} ) = I + {\sum }_{j = 1}^{{N}_{M}} {M}_{ij} {γ}_{j} + {\sum }_{k = 1}^{{N}_{E}} {E}_{ik} {𝒳}_{k} \qquad ( 23 )$$

For the HIV data set, Wᵢ is the replicative capacity (e.g. fitness) for sequence i. I is the intercept, which represents the log fitness of the NL4-3 reference sequence. This should be zero in absence of drugs (and log (0.1) in presence of drugs), but in order to account for possible systematic biases, it is included as a variable in the model. γⱼ represents the main effect of the j^{th} variant and Mᵢⱼ is a variable that describes the presence of that variant in sequence i. Because the sequences in the HIV data-set were result of population sequencing, there were occasional uncertainties at a locus, where 2 or more variants were present, at that locus, in the population. Mᵢⱼ is therefore a real number in the range 0≦Mᵢⱼ≦1 that defines the probability that any randomly picked individual virion in the population corresponding to sequence i has variant j. Similarly, χₖ quantifies the effect of the k^{th} interaction and Eᵢₖ is a variable that defines the probability of that interaction being present. If the k^{th} interaction corresponds to the pairwise combination of variants j and l then Eᵢₖ is calculated as MᵢⱼMᵢₗ. Analysis of the data showed that there were altogether 659,654 independent effects. If main effects or interactions always co-occur with other main effects or interactions, the effect that is attributable to the linked group is distributed evenly over all these coefficients as a result of the ridge regression methodology employed.

### 3. Data Structure

Applying the above formalisms to the HIV data, the matrix Z is a representation of the sequence data is given by:

Zᵢⱼ=P (randomly chosen individual from population sequence i has effect j). (24)

The function ƒ(z) depends on the model used. For the model including only main effects (ME)ƒ(z)=z. For the models including interactions and main effects (MEEP), ƒ(z) is a function that enumerates the presence of interactions from the sequence z. In this case, ƒ projects from the space defined by presence of amino acid variants into a higher dimensional feature space featuring both variants and the interactions between them.

Each variant included in a model adds a dimension. Hence, the number of dimensions in an ME model is given by the number of variants in the data set. For models that include interactions, each interaction (pairwise or N-wise) adds a further dimension. For example, for the MEEP model, if there are 100 amino acid variants and we include all pairwise interactions, this gives 5,050 dimensions in feature space (100 amino acid variants+4,950 interactions). For models including higher orders of interactions the dimensionality of the problem increases rapidly. For example, including all three-way interactions gives a further 161,700 interactions for total of 166,750 dimensions, an already difficult problem, in terms of compute-time and memory usage. Including all N-wise interactions up to 100-wise would lead to 1.268×10³⁰ coefficients.

For each cross-validation two subsets of data from the database can be selected. For the HIV dataset, the larger data set, consisting of 65,000 sequences and corresponding fitness values, was used to estimate main effects and interactions. The smaller data set, consisting of 5,000 sequences and fitness values, was not used for model fitting but reserved only for the purpose of quantifying the goodness of the model fit.

### 4. Kernelization of the Model

By using the GKRR algorithm, it is not necessary to actually project the data point into feature space. Thus it is theoretically possible to include an infinite effective number of dimensions, so long as the dot product in feature space is computable (i.e. the function g in equation 17 exists). The dot product in feature space between two genomes can be viewed as a calculation of the number of variants and interactions that the two genomes share. Thus, the dot product for two genomes that share 3 variants (assuming no interactions in the model) will be 3. Logically, the only interactions that will be shared will be those between mutations that are shared. Thus, 3 shared variants lead to 3 shared pairwise interactions and 1 shared 3-wise interaction, giving a dot-product of 3+3+1=0.7.

It is thus possible to construct an equation to calculate the dot product directly in feature space

$${K}_{ij} = {\sum }_{k ∈ A}^{ } ( \begin{matrix}{z}_{i}^{T} {z}_{j} \\ k\end{matrix} ) \qquad ( 1 )$$

with zᵢ being the i^{th} row of Z.

The set A refers to the set of order-interactions to be included, respectively. For example, with A={1, 2}, main effects and pairwise interactions are included. The parameter settings for the ME and MEEP models are:

ME A={1}

MEEP A={1,2} (2)

By including integers of 3 or higher in A, it is possible to include three-way, and higher order, interactions without any increase in memory consumption and minimal increase in computational load. However, the analysis herein used α≦2∀ α aεA, thereby including only main effects and/or pairwise interactions. There may be two reasons for this decision. Firstly, while including the extra implicit parameters does not affect computational performance, it can be exactly equivalent in terms of overfitting and thus predictive performance, as if the parameters were explicitly included. The fact that inclusion of even 3-way interactions will send the effective number of parameters into the billions, is a strong argument for restricting the analysis to pairwise interactions. The second reason to restrict the analysis to pairwise interactions is one of purpose. Predictive power is not the primary goal of this analysis; instead the goal is the extraction of meaningful values for the individual fitness effect of mutations and interactions. Since higher order interactions would be increasingly difficult to analyze, it makes sense to include only the parameters of interest.

### Probabilistic Genome and Regions

In that the method may define the genome in terms of probabilities of amino acid variants rather than certainties, the actual number of shared alleles or interactions can be defined in a similarly probabilistic sense as the expected number of common alleles or 2-way interactions that two individual virions, randomly selected, one from each sequence-population, will share. Because the method may specify models that include only intragenic or intergenic interactions, the kernel function must be able to remove those if needed. Thus interaction region matrices may be defined as follows:

$${M}_{ij} = \{ \begin{matrix}1 & \vert allele j is in region i \\ 0 & \vert otherwise\end{matrix} \qquad ( 3 )$$

The most simple region matrix is the universal region matrix U which contains 1 row and 1,859 columns, each entry being set to 1.

To account for intragenic or intergenic mutations, the genetic region matrix G is defined, which contains 1 row per gene and Gᵢⱼ is set to 1 if allele j is in gene i.

If it is desirable to remove intralocus interactions (under the assumption that though multiple alleles exist at each locus in the population, only one can exist, at a time, in an individual) then the loci region matrix L is defined, which contains 1 row per locus and Lᵢⱼ is set to 1 if allele j is located on locus i. If intraloci interactions are desirable, then L must be set to the identity matrix, to remove self-interactions, which are accounted for by the ME component of the model. For the results shown in the examples herein, we use this later formulation (L=I) to account for possible population-level and heterodimer effects.

The expected number of shared interactions between sequences zᵢ and zⱼ in a region is then defined as:

E(R,zᵢ,zⱼ)=Σ(R(zᵢ·zⱼ))² (4)

where · is the element-wise multiplication between two vectors. It should be noted that this equation includes self-interactions (which must be removed using one of the L matrices, as defined above) and each proper interaction is included twice.

Further, it should be noted that the expected number of shared alleles between two sequences is defined as:

ME(i,j)=zᵢ^{T}zⱼ (5)

such that the other models used herein may be defined as follows.

$$\begin{matrix}EP ( i , j ) = \frac{1}{2} [ E ( U , {z}_{i} , {z}_{j} ) - E ( L , {z}_{i} , {z}_{j} ) ] & ( 6 ) \\ MEEP ( i , j ) = EP ( i , j ) + ME ( i , j ) & ( 7 ) \\ ME + INTRA ( i , j ) = \frac{1}{2} [ E ( G , {z}_{i} , {z}_{j} ) - E ( L , {z}_{i} , {z}_{j} ) ] + ME ( i , j ) & ( 8 ) \\ ME + INTER ( i , j ) = \frac{1}{2} [ E ( U , {z}_{i} , {z}_{j} ) - E ( G , {z}_{i} , {z}_{j} ) ] + ME ( i , j ) & ( 9 )\end{matrix}$$

### Illustrative System

FIGS. 9A and 9B show embodiments of illustrative systems suitable for executing one or more of the methods disclosed herein. For example, FIGS. 9A and 9B show diagrams depicting illustrative computing devices in illustrative computing environments according to some embodiments. The system 900 shown in FIG. 9A includes a computing device 910, a network 920, and a data store 930. The computing device 910 and the data store 930 are connected to the network 920. In this embodiment, the computing device 910 can communicate with the data store 930 through the network 920.

The system 900 shown in FIG. 9A includes a computing device 910. A suitable computing device for use with some embodiments may comprise any device capable of communicating with a network, such as network 920, or capable of sending or receiving information to or from another device, such as data store 930. A computing device can include an appropriate device operable to send and receive requests, messages, or information over an appropriate network. Examples of such suitable computing devices include personal computers, cell phones, handheld messaging devices, laptop computers, tablet computers, set-top boxes, personal data assistants (PDAs), servers, or any other suitable computing device. In some embodiments, the computing device 910 may be in communication with other computing devices directly or through network 920, or both. For example, in FIG. 9B, the computing device 910 is in direct communication with data store 930, such as via a point-to-point connection (e.g. a USB connection), an internal data bus (e.g. an internal Serial ATA connection) or external data bus (e.g. an external Serial ATA connection). In one embodiment, computer device 910 may comprise the data store 930. For example, in one embodiment, the data store 930 may comprise a hard drive that is a part of the computer device 910.

A computing device typically will include an operating system that provides executable program instructions for the general administration and operation of that computing device, and typically will include a computer-readable storage medium (e.g., a hard disk, random access memory, read only memory, etc.) storing instructions that, when executed by a processor of the server, allow the computing device to perform its intended functions. Suitable implementations for the operating system and general functionality of the computing device are known or commercially available, and are readily implemented by persons having ordinary skill in the art, particularly in light of the disclosure herein.

In the embodiment shown in FIG. 9A, the network 920 facilitates communications between the computing device 910 and the data store 930. The network 920 may be any suitable number or type of networks or links, including, but not limited to, a dial-in network, a local area network (LAN), wide area network (WAN), public switched telephone network (PSTN), the Internet, an intranet or any combination of hard-wired and/or wireless communication links. In one embodiment, the network 920 may be a single network. In other embodiments, the network 920 may comprise two or more networks. For example, the computing device 910 may be connected to a first, network and the data store 930 may be connected to a second network and the first and the second network may be connected. In one embodiment, the network 920 may comprise the Internet. Components used for such a system can depend at least in part upon the type of network and/or environment selected. Protocols and components for communicating via such a network are well known and will not be discussed herein in detail. Communication over the network can be enabled by wired or wireless connections, and combinations thereof. Numerous other network configurations would be obvious to a person of ordinary skill in the art.

The system 900 shown in FIG. 9A includes a data store 930. The data store 930 can include several separate data tables, databases, or other data storage mechanisms and media for storing data relating to a particular aspect. It should be understood that there can be many other aspects that may need to be stored in the data store, such as to access right information, which can be stored in any appropriate mechanism or mechanisms in the data store 930. The data store 930 may be operable to receive instructions from the computing device 910 and obtain, update, or otherwise process data in response thereto.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computing devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media, and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

### Illustrative Computing Device

FIGS. 10A and 10B show block diagrams depicting exemplary computing devices according to various embodiments. According to the embodiment shown in FIG. 10A, the computing device 1000 comprises a computer-readable medium such as memory 1010 coupled to a processor 1020 that is configured to execute computer-executable program instructions (or program code) and/or to access information stored in memory 1010. A computer-readable medium may comprise, but is not limited to, an electronic, optical, magnetic, or other storage device capable of providing a processor with computer-readable instructions. Other examples include, but are not limited to, a floppy disk, CD-ROM, DVD, magnetic disk, memory chip, ROM, RAM, SRAM, DRAM, CAM, DDR, flash memory such as NAND flash or NOR flash, an ASIC, a configured processor, optical storage, magnetic tape or other magnetic storage, or any other medium from which a computer processor can read instructions. In one embodiment, the computing device 1000 may comprise a single type of computer-readable medium such as random access memory (RAM). In other embodiments, the computing device 1000 may comprise two or more types of computer-readable medium such as random access memory (RAM), a disk drive, and cache. The computing device 1000 may be in communication with one or more external computer-readable mediums such as an external hard disk drive or an external DVD drive.

As discussed above, the embodiment shown in FIG. 10A comprises a processor 1020 which is configured to execute computer-executable program instructions and/or to access information stored in memory 1010. The instructions may comprise processor-specific instructions generated by a compiler and/or an interpreter from code written in any suitable computer-programming language including, for example, C, C++, C#, Visual Basic, Java, Python, Perl, JavaScript, and ActionScript®. In an embodiment, the computing device 1000 comprises a single processor 1020. In other embodiments, the device 1000 comprises two or more processors. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

The computing device 1000 as shown in FIG. 10A comprises a network interface 1030. In some embodiments, the network interface 1030 is configured for communicating via wired or wireless communication links. For example, the network interface 1030 may allow for communication over networks via Ethernet, IEEE 802.11 (Wi-Fi), 802.16 (Wi-Max), Bluetooth, infrared, etc. As another example, network interface 1030 may allow for communication over networks such as CDMA, GSM, UMTS, or other cellular communication networks. In some embodiments, the network interface may allow for point-to-point connections with another device, such as via the Universal Serial Bus (USB), 1394 FireWire, serial or parallel connections, or similar interfaces. Some embodiments of suitable computing devices may comprise two or more network interfaces for communication over one or more networks. In some embodiments, such as the embodiment shown in FIG. 10B, the computing device may include a data store 1060 in addition to or in place of a network interface.

Some embodiments of suitable computing devices may comprise or be in communication with a number of external or internal devices such as a mouse, a CD-ROM, DVD, a keyboard, a display, audio speakers, one or more microphones, or any other input or output devices. For example, the computing device 1000 shown in FIG. 10A is in communication with various user interface devices 1040 and a display 1050. Display 1050 may use any suitable technology including, but not limited to, LCD, LED, CRT, and the like.

In various embodiments, suitable computing devices may be a server, a desktop computer, a personal computing device, a mobile device, a tablet, a mobile phone, or any other type of electronic devices appropriate for providing one or more of the features described herein. In at least one aspect, the invention provides systems for carrying out the analysis described above. Thus, in some embodiments, the present invention comprises a computer-readable medium on which is encoded programming code for the generalized ridge regression methods described herein. Also in some embodiments, such as described above with respect to FIGS. 9-10, the invention comprises a system comprising a processor in communication with a computer-readable medium, the processor configured to perform the generalized ridge regression methods described herein. Suitable processors and computer-readable media for various embodiments of the present invention are described in greater detail above.

Thus, in certain embodiments, the invention comprises a system for predicting the activity of at least one gene comprising: a computer readable medium; and a processor in communication with the computer readable medium, the processor configured to apply a model based on generalization of ridge regression (GRR) analysis to estimate the effects of individual mutations in the at least one gene. The processor may, in certain embodiments, be further in communication with a database comprising data for a plurality of sequences for the portion of the at least one gene, where the processor is configured to compare the nucleic acid and/or amino acid sequence of the portion of the at least one gene to the data of the plurality of sequences for the portion of the at least one gene to determine if there is a mutation in the portion of the at least one gene in the biological sample obtained from the subject.

In other embodiments, the invention comprises a computer readable medium on which is encoded program code for predicting the activity of at least one gene, the program code comprising code for applying a model based on generalization of ridge regression analysis to estimate the effects of individual mutations in the at least one gene. In certain embodiments, the programming code comprises code configured to compare the amino acid and/or nucleic acid sequence of the portion of the at least one gene to the data for a plurality of sequences for the portion of the at least one gene stored in a database to determine if there is a mutation in the portion of the at least one gene in the biological sample obtained from the subject.

For some embodiments of the systems and computer readable media of the invention, the subject may be exposed to a drug or other compound (e.g., an antibody) that can affect the biological activity of the at least one gene.

For some embodiments of the systems and computer readable media of the invention the GRR model may be as follows:

$$log ( {W}_{i} ) = I + {\sum }_{j = 1}^{{N}_{M}} {M}_{ij} {γ}_{j} + {\sum }_{k = 1}^{{N}_{E}} {E}_{ik} {𝒳}_{k}$$

wherein Wᵢ is the biological activity for sequence I, I is the intercept, which represents the biological activity for a non-mutated reference sequence, γⱼ represents the main effect of the j^{th} variant and Mᵢⱼ is a variable that describes the presence of that variant in sequence i.

Some embodiments of the systems and computer readable media of the invention may be applied to various genes. In certain embodiments, the at least one gene comprises the reverse transcriptase (RT) and protease (PR) genes of an HIV virus. For example, in at least some embodiments, the biological activity Wᵢ is replicative capacity for a virus.

As noted herein, the sequence of the portion of the at least one gene and the biological activity of interest as assessed for a particular subject may be compared to a database of amino acid and/or nucleic acid sequences and biological activity as assess for a plurality of subjects. Thus, in certain embodiments of the systems and computer readable media, the database comprises data for the biological activity as measured in a plurality of samples from which the sequence of the portion of the at least one gene was determined. Also, the database may include amino acid and/or nucleic acid sequence for the at least one gene from a plurality of subjects who have been exposed to a drug that can affect the biological activity of the at least one gene.

For some embodiments of the systems and computer readable media of the invention, mutations in a gene may be assessed individually or epistatic interactions may be considered. Thus in certain embodiments, the GRR analysis estimate the fitness effects of individual mutations in isolation (main effects) and/or the fitness effects resulting from pairwise epistasis between these mutations (interactions). For example, the analysis may estimate the effect of mutations in isolation as main effects (ME) either alone or in combination with other mutations as epistasis effects (MEEP) so as to provide a prediction of the biological activity of the at least one gene.

A variety of statistical techniques may be employed to develop the model. In certain embodiments, the GRR analysis comprises a weighted ridge regression. Such weighted regression techniques are described in detail herein. For example, in certain embodiments, the GRR analysis comprises a weighted kernel ridge regression.

Thus, in an embodiment, the starting point may comprise data (100) generated from a data base of assays for gene activity (100A) and gene sequences (100B). Once the data has been collected (110), it may be compiled (120) and/or transformed if necessary using any standard spreadsheet software such as Microsoft Excel, FoxPro, Lotus, or the like. In an embodiment, the data are entered into the system for each experiment. Alternatively, data from previous runs are stored in the computer memory (160) and used as required.

At each point in the analysis, the user may input instructions via a keyboard (190), floppy disk, remote access (e.g., via the internet) (200), or other access means. The user may enter instructions including options for the run, how reports should be printed out, and the like. Also, at each step in the analysis, the data may be stored in the computer using a storage device common in the art such as disks, drives or memory (160). As is understood in the art, the processor (170) and I/O controller (180) are required for multiple aspects of computer function. Also, in a embodiment, there may be more than one processor.

The data may also be processed to remove noise (130). In some cases, the user, via the keyboard (190), floppy disk, or remote access (200), may want to input variables or constraints for the analysis, as for example, the threshold for determining noise.

In the next step, generalized ridge regression analysis is performed as described herein (140). The results of the analysis may then be compiled and provided in a form for review by a user (150).

### RELATED REFERENCES

Hinkley et al. Nature Genetics, Vol. 43, pp. 487-89 (2011) is incorporated by reference as though fully set forth herein.

### EXAMPLES

The present invention may be better understood by reference to the following non-limiting examples.

### Data.

The measure of fitness used in this study, replicative capacity (RC), is an assay that quantifies the total amount of viral reproduction in a single replication cycle. The viral samples are obtained by inserting subject virus derived amplicons of HIV-1 PR and RT into an NL4-3 based HIV vector. RC is then independently measured for each sample, in the absence of drugs and in the presence of 15 individual drugs at the concentration at which the drug sensitive NL4-3 based control strain has 10% of its RC in absence of drugs.

The drugs used here are 6 PR inhibitors (PI), 6 nucleoside RT inhibitors (NRTI) and 3 non-nucleoside RT inhibitors (NNRTI). The drugs used were as follows: (A) the protease inhibitors (PI) amprenavir (AMP), indinavir (IDV), lopinavir (LPV), nelfinavir (NFV), ritonavir (RTV), and saquinavir (SQV); (B) the nucleoside reverse transcriptase inhibitors (NRTI) abacavir (ABC), didanosine (ddI), lamivudine (3TC), stavudine (d4T), zidovudine (ZDV), and tenofovir (TFV); and (C) the non-nucleoside reverse transcriptase inhibitors (NNRTI) delavirdine (DLV), efavirenz (EFV), and nevirapine (NVP).

Amino acid sequences of the PR gene and the partial RT gene were obtained by population sequencing for all virus samples included in this analysis [6].

### Statistical Analysis.

The fitness effects that are attributable to individual amino acid variants independent of the genetic context (e.g. main effects) and the fitness effects attributable to pairwise epistasis between variants (e.g. interactions) were quantified by fitting the following model:

$$log ( {W}_{i} ) = I + {\sum }_{j = 1}^{{N}_{M}} {M}_{ij} {γ}_{j} + {\sum }_{k = 1}^{{N}_{E}} {E}_{ik} {𝒳}_{k}$$

Here, Wᵢ is the replicative capacity (e.g. fitness) of sequence i. I is the intercept, which represents the log fitness of the NL4-3 reference sequence. The parameter γⱼ represents the main effect of the j^{th} variant and Mᵢⱼ is a variable that accounts for the presence or absence of that variant in sequence i. Similarly, χₖ represents the interaction of the k^{th} combination of variants and Eᵢₖ is a variable that accounts for the presence or absence of that combination of variants in the sequence. The ME model uses only the 1,859 Mᵢⱼ terms to compute predicted fitness and the MEEP model adds 802,611 Eᵢₖ terms to this model. These models are explained in depth herein.

The model is fitted by generalized kernel ridge regression (GKRR), a technique that combines the fitting of non-normal error structure by the Generalized Linear Model (GLM) with the capability of Kernel Ridge Regression to fit data with fewer observations than dimensions.

The change of frequency of single amino acid variants in HIV-1 PR and RT was determined based on 44,119 sequences obtained from the Stanford HIV Drug Resistance derived from treated and untreated subjects (Numbers of sequences: RT/treated=7,232, RT/untreated=12,022, PR/treated=10,011, PR/untreated=14,854). The fitness gain was estimated as the difference between the maximal beneficial fitness effect of an amino acid variant in presence of drugs versus the fitness effect in absence of drugs. Fitness effects of the amino acid variant were measured relative to the consensus amino acid variant in untreated subjects. The significance of the correlation between fitness gain in presence versus absence of drugs and frequency change in treated versus untreated subjects was calculated based on a Spearman rank correlation (N=1, 169 amino acid variants, p<10⁻¹⁶ and ρ=0.33).

To test for statistical significance of correlations between epistatic effects and protein structure we used bootstrapping. To this end bootstrapped matrices of epistatic interactions were generated by shuffling rows and columns of the estimated epistatic interaction matrix. 100,000 bootstraps were used to test to infer statistical significance of the enrichment of epistatic interactions in the within HIV-1 PR structural domains and between these structural domains and the remainder of the protein. 100,000 bootstraps were used to test infer statistical significance of the spearman rank correlation coefficient between strength of epistatic interactions between amino acid residues and their physical proximity in the 3D structure of PR.

While the invention has been described and illustrated with reference to certain embodiments thereof, those skilled in the art will appreciate that various changes, modifications and substitutions can be made therein without departing, from the spirit and scope of the invention. All patents, published patent applications, and other non-patent references referred to herein are incorporated by reference in their entireties.

### Example 1

The replicative capacity predictor (RC-predictor) was assessed by using two clinical datasets containing clinical outcomes and amino acid sequences from the Swiss HIV Cohort Study (SHCS) (available online at www.shcs.ch website). The evaluation focused on subjects for whom amino-acid sequences corresponding to the entire protease and the first 303 amino acids of reverse transcriptase were available. Only sequences generated from therapy-naive subjects were considered. The first dataset contained sequences with HIV RNA virus load measurements (RNA-load set) from 2,176 patients. When multiple RNA-load measurements were available for a subject, the viral load measurement that was derived closest to the sampling of the sequence was selected for the analysis. This assured that the sequence and the RNA-load measurements were generated at similar time points for most patients. The second dataset contained 53 subjects for whom sequences were available at two time points, which were at least 6 months apart (longitudinal data set). Further details on the data set are available in Kouyos et al. Clin. Infect. Dis. Vol. 52, pp. 532-539 (2011).

The predicted RC (pRC) with respect to two clinically relevant quantities or processes were assessed: (1) the relation between pRC and the set-point virus-load; and (2) the temporal change of pRC in the course of an HIV-1 infection.

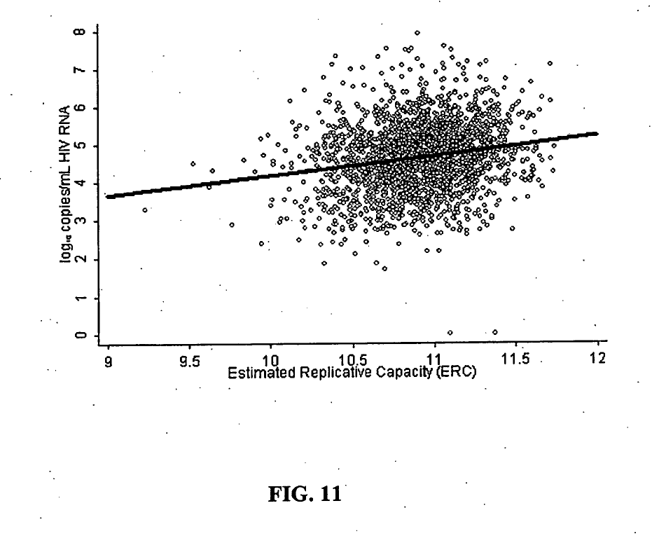

For the RNA-load dataset (2,176 patients), a highly significant correlation between pRC and virus load (F-Test p<0.001; see FIG. 11) was observed. The fraction of variance in virus load explained through the pRC is low (R²=3.4%). The effect of pRC on virus load remains highly significant (p<0.001) when ethnicity, risk group, sex, time of infection, and the laboratory that generated the data are controlled in a multivariate regression model.

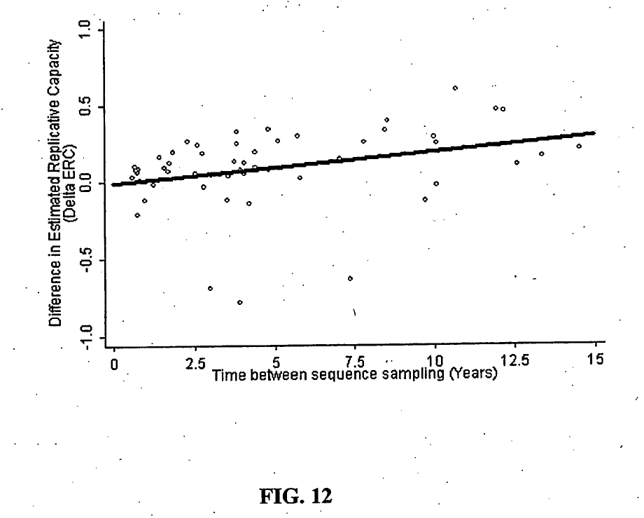

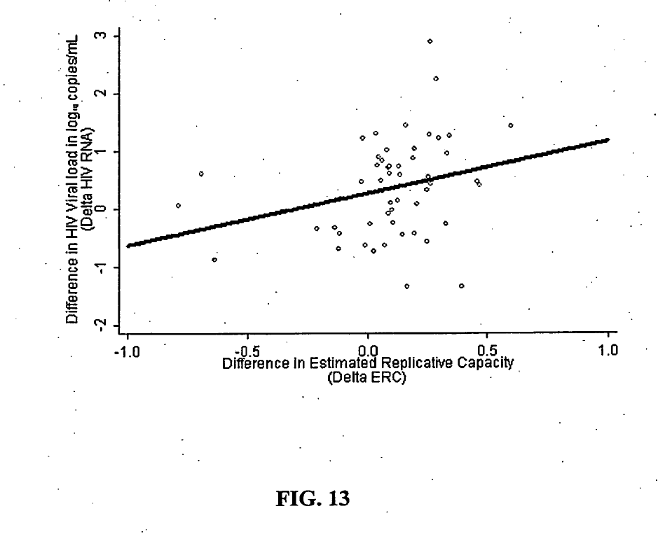

Based on the longitudinal dataset, pRC increased during the course of an infection. Among 53 patients with sequences available at two time-points with separation by at least 6 months, the pRC at the later time point was significantly higher than the pRC at the earlier time-point (Wilcoxon signed rank test p=2*10⁵). Furthermore, the difference between the pRC at the earlier and the later time point increased significantly with increasing time intervals (FIG. 12) (F-Test p=0.005). In this longitudinal dataset, the temporal change in pRC correlated significantly (p=0.04) with the temporal change in RNA-load (FIG. 13).

That which is claimed is:

1. A method to predict the activity of at least one gene comprising:
(a) obtaining an amino acid and/or nucleic acid sequence of a portion of the at least one gene from a biological sample obtained from a subject, where the portion of the at least one gene comprises a region of the gene that if mutated can affect the activity of the at least one gene;
(b) measuring a biological activity that depends on the activity of the at least one gene in the sample;
(c) comparing the amino acid and/or nucleic acid sequence of the portion of the at least one gene to sequence data stored in a database, the data comprising a plurality of sequences for the portion of the at least one gene and for which the biological activity of the at least one gene has been evaluated;
(d) determining if there is a mutation in the portion of the at least one gene in the biological sample obtained from the subject; and
(e) applying a model based on generalization of ridge regression (GRR) analysis to estimate the effects of individual mutations in the at least one gene for the subject.

2. The method of claim 1, wherein the GRR model is as follows:
$$log ( {W}_{i} ) = I + {\sum }_{j = 1}^{{N}_{M}} {M}_{ij} {γ}_{j} + {\sum }_{k = 1}^{{N}_{E}} {E}_{ik} {𝒳}_{k}$$
wherein Wᵢ is the biological activity for sequence I, I is the intercept, which represents the biological activity for a non-mutated reference sequence, γⱼ represents the main effect of the j^{th} variant and Mᵢⱼ is a variable that describes the presence of that variant in sequence i.

3. The method of claim 1, wherein the at least one gene comprises the reverse transcriptase (RT) and protease (PR) genes of an HIV virus.

4. The method of claim 1, wherein the biological activity Wᵢ is replicative capacity for a virus.

5. The method of claim 1, wherein the subject has been exposed to a drug that can affect the biological activity of the at least one gene.

6. The method of claim 1, wherein the database further comprises at least one of data for the biological activity as measured in a plurality of samples from which the sequence of the portion of the at least one gene was determined, and/or amino acid and/or nucleic acid sequences from samples which, and/or subjects who, have been exposed to a drug that can affect the biological activity of the at least one gene.

7. The method of claim 1, wherein the GRR analysis estimate the fitness effects of individual mutations in isolation (main effects) and/or the fitness effects resulting from pairwise epistasis between these mutations (interactions).

8. The method of claim 1, wherein the GRR analysis estimates the effect of mutations in isolation as main effects (ME) either alone or in combination with other mutations as epistasis effects (MEEP) so as to provide a prediction of the biological activity of the at least one gene.

9. The method of claim 1, wherein the GRR analysis comprises a weighted ridge regression.

10. The method of claim 1, wherein the GRR analysis comprises a weighted kernel ridge regression.

11. A method to develop a model to predict the activity of at least one gene comprising:
(a) obtaining the amino acid and/or nucleic acid sequence of a portion of the at least one gene from a biological sample obtained from a subject, where the portion of the at least one gene comprises a region of the gene that if mutated can affect the activity of the at least one gene;
(b) measuring a biological activity that depends on the activity of the at least one gene in the sample;
(c) comparing the amino acid and/or nucleic acid sequence of the portion of the at least one gene to sequence data stored in a database, the data comprising a plurality of sequences for the portion of the at least one gene and for which the biological activity of the at least one gene has been evaluated;
(d) determining if there is a mutation in the portion of the at least one gene in the biological sample obtained from the subject; and
(e) applying a generalized ridge regression (GRR) analysis to develop a model to estimate the effects of individual mutations in the at least one gene for the subject.

12. A system comprising:
a computer readable medium; and
a processor in communication with the computer readable medium, the processor configured to:
receive sequence data, the sequence data representing an amino acid and/or nucleic acid sequence of a portion of at least one gene from a biological sample obtained from a subject;
measure a biological activity that depends on the activity of the at least one gene;
access other sequence data and previously evaluated biological activity of the at least one gene;
compare the received sequence data to the other sequence data;
determine whether there is a mutation in the received sequence data; and
in response to a determination that there is the mutation in the received sequence data, estimate the effects of at least one individual mutation by at least applying a model based on a generalization of ridge regression (GRR) analysis.

13. The system of claim 12, further comprising at least one database in communication with the processor, wherein the at least one database comprises the other sequence data.

14. The system of claim 13, wherein the at least one database further comprises data for the biological activity as measured in a plurality of samples from which the sequence of the portion of the at least one gene was determined.

15. The system of claim 13, wherein the at least one database further comprises amino acid and/or nucleic acid sequences associated with a plurality of subjects who have been exposed to a drug that can affect the biological activity of the at least one gene.

16. The system of claim 12, wherein the GRR analysis estimates the fitness effects of individual mutations in isolation (main effects) and/or the fitness effects resulting from pairwise epistasis between these mutations (interactions).

17. The system of claim 12, wherein the GRR analysis estimates the effect of mutations in isolation as main effects (ME) or in combination with other mutations as epistasis (EP) effects (MEEP) so as to provide a prediction of the biological activity of the at least one gene.

18. The system of claim 12, wherein the GRR analysis comprises a weighted ridge regression.

19. The system of claim 12, wherein the GRR analysis comprises a weighted kernel ridge regression.

20. The system of claim 12, wherein the at least one gene comprises the reverse transcriptase (RT) and protease (PR) genes of an HIV virus.

21. The system of claim 12, wherein the biological activity is replicative capacity.

22. The system of claim 12, wherein the subject has been exposed to a drug that can affect the biological activity of the at least one gene.

23. The system of claim 12, wherein the model is as follows:
$$log ( {W}_{i} ) = I + {\sum }_{j = 1}^{{N}_{M}} {M}_{ij} {γ}_{j} + {\sum }_{k = 1}^{{N}_{E}} {E}_{ik} {𝒳}_{k}$$
wherein Wᵢ is the biological activity for sequence I, I is the intercept, which represents the biological activity for a non-mutated reference sequence, γⱼ represents the main effect of the j^{th} variant and Mᵢⱼ is a variable that describes the presence of that variant in sequence i.

24. A computer readable medium comprising program code comprising:
program code for receiving sequence data, the sequence data representing an amino acid and/or nucleic acid sequence of a portion of at least one gene from a biological sample obtained from a subject;
program coded for measuring a biological activity that depends on the activity of the at least one gene;
program code for accessing other sequence data and previously evaluated biological activity of the at least one gene;
program code for comparing the received sequence data to the other sequence data;
program code for determining whether there is a mutation in the received sequence data; and
program code for, in response to a determination that there is the mutation in the received sequence data, estimating the effects of at least one individual mutation by at least applying a model based on a generalization of ridge regression (GRR) analysis.

25. The computer readable medium of claim 24 wherein program code for accessing other sequence data and previously evaluated biological activity of the at least one gene comprises program code for retrieving the other sequence data from at least one database, the at least one database comprising the other sequence data.

26. The computer readable medium of claim 24 wherein program code for accessing other sequence data and previously evaluated biological activity of the at least one gene comprises program code for retrieving data associated with previously evaluated biological activity from at least one database.

27. The computer readable medium of claim 24 further comprising program code for storing sequence data in at least one database, the sequence data comprising amino acid and/or nucleic acid sequences from a plurality of subjects who have been exposed to a drug that can affect the biological activity of the at least one gene.

28. The computer readable medium of claim 24, wherein the GRR analysis estimates the fitness effects of individual mutations in isolation (main effects) and/or the fitness effects resulting from pairwise epistasis between these mutations (interactions).

29. The computer readable medium of claim 24, wherein the GRR analysis estimates the effect of mutations in isolation as main effects (ME) or in combination with other mutations as epistasis (EP) effects (MEEP) so as to provide a prediction of the biological activity of the at least one gene.

30. The computer readable medium of claim 24, wherein the GRR analysis comprises a weighted ridge regression.

31. The computer readable medium of claim 24, wherein the GRR analysis comprises a weighted kernel ridge regression.

32. The computer readable medium of claim 24, wherein the at least one gene comprises the reverse transcriptase (RT) and protease (PR) genes of an HIV virus.

33. The computer readable medium of claim 24, wherein the biological activity is replicative capacity.

34. The computer readable medium of claim 24, wherein the model is as follows:
$$log ( {W}_{i} ) = I + {\sum }_{j = 1}^{{N}_{M}} {M}_{ij} {γ}_{j} + {\sum }_{k = 1}^{{N}_{E}} {E}_{ik} {𝒳}_{k}$$
wherein Wᵢ is the biological activity for sequence I, I is the intercept, which represents the biological activity for a non-mutated reference sequence, γⱼ represents the main effect of the j^{th} variant and Mᵢⱼ is a variable that describes the presence of that variant in sequence i.
